(19) United States
(12) Patent Application Publication
(10) Pub. No.: US 2005/0084086 A1
(43) Pub. Date: Apr. 21, 2005

(54) Systems and methods for conferencing among governed and external participants

(76) Inventor: Thomas H. Hesse, Mesa, AZ (US)

Correspondence Address: Squire, Sanders & Dempsey L.L.P.;Suite 2700, Two Renaissance Squire, 40 North Central Avenue, Phoenix, AZ, 85004-4498, US

(21) Appl. No.: 11/005,545

(22) Filed: Dec. 6, 2004

Related U.S. Application Data
(63) Continuation-in-part of application No. 10/076,276, filed on Feb. 15, 2002.

(51) Int. Cl. H04M 3/42

(52) U.S. Cl. 379/202.01

(57) ABSTRACT

A video conference system for an enterprise facilitates conferences among participants governed by the policies of the enterprise and other participants. The system includes conference participant stations for use by governed participants and a gateway that facilitates linking through a public network to conference participant stations used by those external to the enterprise. The system includes barriers to access to data and processes proprietary to the enterprise. A related method may invoke either paid or unpaid video conferencing on a public network.

### CROSS-REFERENCE TO RELATED APPLICATIONS

This application is a continuation in part of and claims priority from U.S. patent application Ser. No. 10/076,276 filed Feb. 15, 2002 by Thomas H. Hesse.

### FIELD OF THE INVENTION

Embodiments of the present invention relate to conference systems and methods of operation of conference systems.

### BACKGROUND OF THE INVENTION

In a conventional video conference system, the participants may be notified to attend the conference at particular locations. Each location typically has one installed video conference facility including for example microphones, cameras, and network links for communication to several other similar facilities. The communication typically includes audio and video signals used to support business conversation, business graphics, and eye contact among the participants. If a participant arrives at a proper location for the scheduled video conference and for any reason the conference cannot proceed, no provision is made for making a best efforts attempt at accomplishing a business purpose of the video conference.

Without systems and methods according to various embodiments of the present invention, attempts at using video conferencing will continue to result in frustration in some cases because the underlying business purposes or personal purposes for the conference can be frustrated. The difficulty in establishing a value for the loss or damage to business relationships due to unreliable conventional video conferencing systems does not make unreasonable the assertion that unsatisfactory video conferencing may have enormous effects on those who rely on video conferencing for business relationships. Also, by reducing factors that contribute to unreliable video conferencing, future use of video conferencing according to the present invention may expand to meet new applications.

In some situations it is desirable to limit the video conferencing privileges of an individual or class of individuals. For example, video conferencing may be limited by an employer, group, or government over the individual to assure compliance with policies, ethics, to promote safety, or to limit risk to the individual, employer, group, or government. Conventional video conference systems make no provision for assuring such compliance. Without systems and methods of the present invention, desired functions cannot be economically obtained, and significant new uses of video conferencing systems cannot be made.

### SUMMARY OF THE INVENTION

A method, according to various aspects of the present invention, arranges a conference among governed and external participants. The method, performed by a computer system, includes in any order: (a) receiving a request for a conference; (b) receiving unsolicited data describing governed participant availability; and (c) scheduling the conference with reference to the unsolicited data.

Receiving unsolicited data presents a barrier to unauthorized access to any other data from the source of the unsolicited data. For example, when the request is received from an external participant via a public network, the barrier makes difficult any other access to the source of unsolicited data.

A conference services gateway, according to various aspects of the present invention, includes an interface to a public network, an interface to an enterprise network, and a server coupled to these interfaces. The public network provides communication from the server to a first provided conference participant station. The enterprise network provides communication with a second provided conference participant station. The enterprise network couples a first database to the server for describing availability of governed participants. The server repeatedly receives data from the first database for posting to a second database so that scheduling a conference to include the first and second conference participant stations is accomplished with reference to the second database and without read access to the first database.

### BRIEF DESCRIPTION OF THE DRAWING

Embodiments of the present invention will now be further described with reference to the drawing, wherein like designations denote like elements, and:

FIG. 1 is a functional block diagram of a video conferencing system according to various aspects of the present invention;

FIG. 2 is a data flow diagram for processes performed by the system of FIG. 1;

FIG. 3 is a functional block diagram of an implementation of the video conferencing system of FIG. 1;

FIG. 4 is a functional block diagram of a switch used in the video conferencing system of FIG. 3;

FIG. 5 is a process flow diagram of a method for making a reservation according to various aspects of the present invention;

FIG. 6 is a process flow diagram of a method for revising reservations according to various aspects of the present invention;

FIGS. 7A through 7N present a class diagram of a database used in the system of FIGS. 1 and 2;

FIG. 8 is a process flow diagram of a method for conducting a conference according to various aspects of the present invention;

FIG. 9A through 9M present a class diagram of database used in the system of FIGS. 1 and 2;

FIG. 10 is a process flow diagram of a method for scheduling a conference according to various aspects of the present invention;

FIG. 11 is a functional block diagram of a video conferencing system according to various aspects of the present invention;

FIG. 12 is a data flow diagram of a method performed by the video conferencing system of FIG. 12; and

FIG. 13 is a functional block diagram of an implementation of the video conferencing system of FIG. 11.

### DETAILED DESCRIPTION OF THE PREFERRED EMBODIMENTS

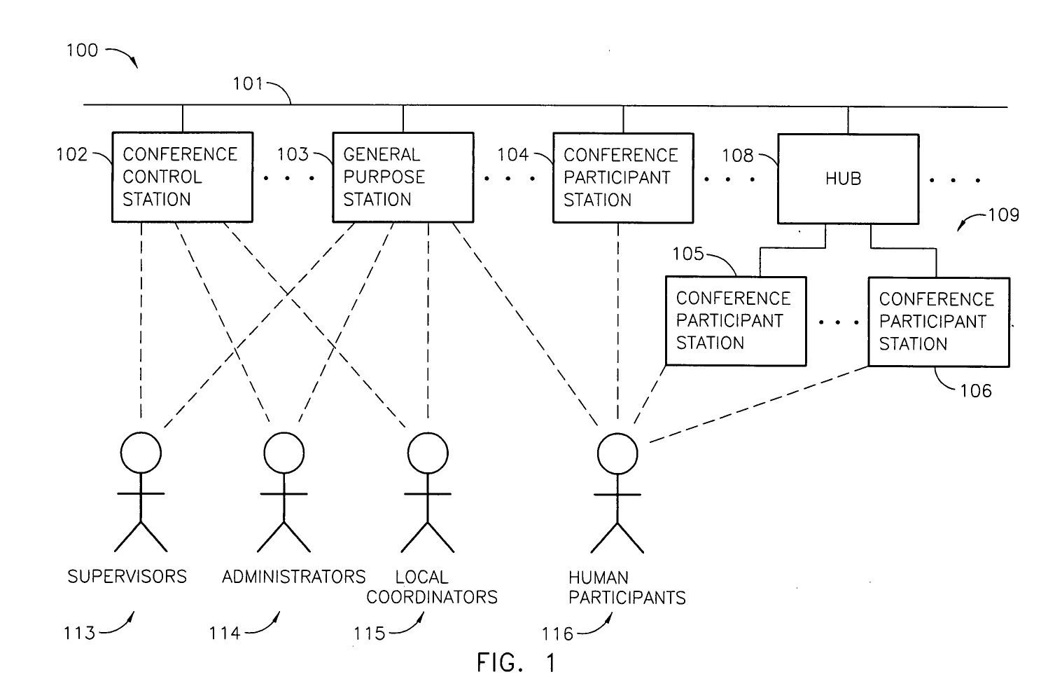

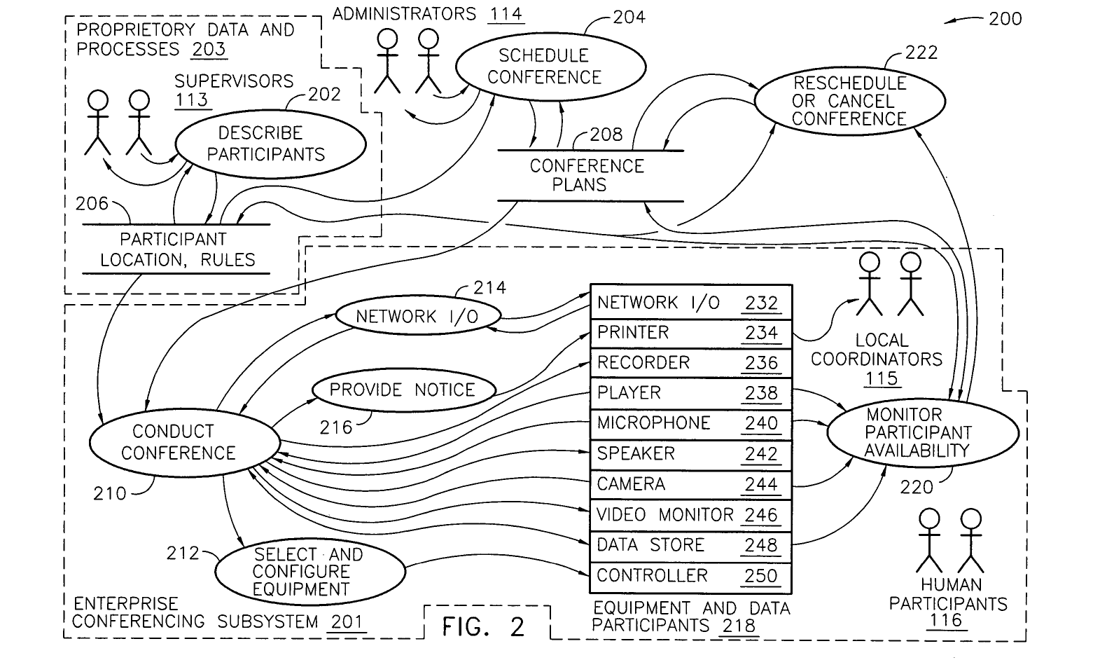

A video conference generally allows each human participant to hear other participants talk and allows each participant to see each other participant, for example, while that participant is speaking. The video conference may include presentations of audio and video programming (e.g., a photograph, a slide show, business graphics, an animation, a movie, or sound recordings) for some or all participants. Participants generally participate in a conference from physically separate locations—each such location in communication with the others via a conventional network that supports audio, video, and presentations. According to various aspects of the present invention, a video conference may substantially achieve an original purpose for conducting the video conference in spite of changes in the availability of participants (e.g., human participant or equipment participant), particular video conference stations, and particular communication links. For example, video conference system 100 of FIGS. 1-2 includes communication network 101; conference control stations 102; general purpose stations 103; conference participant stations 104; hubs 108; and conference participant stations 105 and 106 coupled to hub 108 by links 109.

A network provides signal communication via links between stations or sites. Signals may be analog or digital. Network topology may correspond to local area networks, wide area networks, wireless networks, and combinations including gateways and routers. For example, network 101 includes conventional hardware at each station (e.g., network interface cards) and for each link (e.g., cables, routers, or wireless equipment). Network 101 includes conventional software providing data transfer among processes and storage devices located anywhere in system 100. Access to particular processes and to particular data (e.g., files, directories, or storage devices) may be restricted (e.g., using access control lists, user accounts, or operating system partitions). Network 101 may carry audio and video in suitable digital packets. Or, network 101 may include (e.g., in addition to or in place of digital communication) portions of its analog bandwidth for carrying analog signals that convey channels of audio and channels of video using any conventional network technology.

Each site of system 100 may include any number of stations. A site is an arbitrary grouping of stations organized within a physical boundary, within a political organization, for convenience of installing system components, or for achieving system budgets or efficiencies with hubs in particular areas. Alternate implementations include any number of sites and any number of stations per site. A portable station may be temporarily added to network 101 to meet demand for system functions. For example, if a participant is unexpectedly located away from other stations (e.g., in a vehicle, in a confinement zone, or in a medical area), a portable station may be located anywhere access to network 101 (e.g., access to a hub 108 or any link 101) may be gained by wired or wireless techniques.

Users of system 100 include supervisors 113, administrators 114, local coordinators 115, and human participants 116. A single person may use system 100 in multiple roles. Typically, a person that uses system 100 as a human participant does not perform any other of these roles. Supervisors enter and maintain descriptions of participants including the location of participants. Administrators schedule conferences as requested by human participants. Coordinators are generally located in a convenient vicinity of stations used by participants. Coordinators may relocate and configure equipment participants and notify human participants. A coordinator assists participants (e.g., as an escort or receptionist) in getting to particular locations for scheduled conferences.

Different business rules may apply to human participants using video conferencing system 100. A business rule includes any implementation for controlling use of system 100 (e.g., network connectivity, user accounts, access control lists, use of particular protocols, registration of users, privileges of persons to act as users 113-116 during specified periods, privacy of conferences from each other, recording of conferences, and identification of participants). For example, system 100 may be used with various business rules to support conferences involving prisoners, businessmen, students, educators, officers, constituents, clergy, parishioners, group leaders, and group members, to name a few representative environments.

A video conference generally may be scheduled in advance of beginning the conference so that communication links (e.g., 101 and 109) are established in an orderly fashion and so that equipment and human participants will be available at designated locations (e.g., particular permanently installed conference participant stations). When the location of at least some of the participants is known, notice of the video conference and where to go to participate may be conveyed personally in any conventional manner to those participants. Other participants may be informed indirectly: (a) by giving a message to a coordinator; and/or (b) by using communication less direct than face-to-face (e.g., by conveying a message by mail, telephone, voicemail, or email). The location that a particular participant may be directed to may be a location having numerous video conferencing stations (e.g., a multiple station site). The notice or message may specify a particular video conferencing station. By analogy, equipment (e.g., computer systems, any signal source, any signal recorder, or data item) may be scheduled and notified to participate in a video conference. If a particular human participant or a particular equipment is not free to relocate itself (or be available via any conventional communication) to a suitable physical location, notice may be provided to a coordinator (e.g., guard, escort, receptionist, custodian, or equipment manager).

Stations 102-106 include conventional network interfaces, processors (e.g., conventional computer and microcomputer circuits), data storage devices, audio and video devices, and suitable signal processing circuitry arranged to perform functions and methods of the present invention. Conference participant stations 104-106 support participation in a conference by, among other things, displaying video images, providing sound, picking up sound, and picking up visual images. Other functions are reserved to other stations for security reasons or to reduce the complexity and cost of participant stations. A conference participant station includes any equipment sufficient for a participant to participate in a conference. For example, a video conference station for a human participant includes a camera, a video monitor, a microphone, and a speaker. Any conventional interface technology may be used in an alternate implementation that accepts user input for computation or control purposes, for example, the monitor may further include a touch-screen interface, the station may have a sensor to detect that a person is ready to use the station (e.g., proximity switch), the microphone may have voice recognition capability (e.g., to distinguish “yes” and “no” in various languages), the speaker and microphone may be part of a conventional telephone handset that operates a hook switch, or a keypad or keyboard may be included. The station may further include a personal computer for voice recognition, dual tone multiple frequency signals (DTMF) decoding, local processing functions (e.g., menu functions or screen displays and controls), or use as a conventional office workstation.

Particular advantages are realized in systems according to various aspects of the present invention by implementing a participant station in a manner suitable for use by abusive users (e.g., prisoners). Such a station may include a video camera and flat screen LCD monitor installed behind a protective window; and, a telephone handset for microphone and speaker mounted with a hook switch. The hook switch provides a signal indicating that a participant intends to begin participating, continue participating, or discontinue participating in a conference. The LCD monitor may provide video from a camera or cameras at other participating stations as well as screens for instructions on operation of the station.

A conference control station supports making reservations for conferences, revising reservations for conferences, canceling reservations for conferences, and keeping records of conferences. In addition, a conference control station may provide a data entry/edit interface for managing descriptions of participants including data that may be needed for a presentation during a conference. For example, conference control stations 102 include conventional computer workstations for database management and include audio and video capabilities for participating (e.g., as an observer) in any conference (e.g., for security or troubleshooting purposes).

General purpose stations 103 may perform any mix of functions described above with reference to conference control stations 102 and conference participant stations 104.

Alternative implementations of system 100 include systems having general purpose stations for all users (hubs 108 and stations 102 and 104-106 omitted); systems having a mix of conference control stations 102 and conference participant stations (any combination of stations 104-106, hubs 108 being omitted where stations 105-106 are not included); systems having a mix of stations 102 and 103 (hubs 108 and stations 102 and 104-106 omitted); and systems having a mix of conference control stations 102 and conference participant stations (any combination of stations 104-106, hubs 108 being omitted where stations 105-106 are not included). In other implementations of system 100, video and/or audio receiving and/or transmitting may be omitted from one or more of the conference participant stations for a particular conference or omitted from the conference participant station used by the participant. For example, including video receiving for a particular participant may serve as a reward or may be the basis for higher fees billed to that participant.

A hub provides a communication interface between a network link and each of a plurality of point-to-point links. The communication may provide security (e.g., encryption, fire wall functions, time locks). For example, one particular hub of hubs 108 provides communication between a conference participant station 105 and any other station of system 100 via network 101. Each station 105-106 is coupled to the particular hub of hubs 108 by an individual point-to-point link 109. Network 101 is coupled to each hub of hubs 108 via a link 101. In a preferred implementation, a hub includes a processor that, among other things, controls components and participant stations. In such an implementation, conference participant stations may operate as peripherals (e.g., dumb I/O devices) of such a processor. Consequently, processing capabilities of components and participant stations may be reduced or eliminated. Further, such a processor may perform part or all of the operations suitable for supporting use by users 113-116 as discussed above, for example, as within a local context of conference participant stations 105-106.

A conference system architecture according to various aspects of the present invention provides scalable expansion, redundancy, monitored system capabilities, responsive conference rescheduling, and distributed resources. A system architecture is a plan by which system functions are made the responsibility of particular processes or components for efficient performance of system functions and for efficient communication among processes. The system architecture is systematically applied as implementations of the system are developed and expanded. Systems employing this architecture solve the problems and provide the benefits discussed above, expand and contract without disruption of services, and exhibit extraordinary reliability.

For example, system architecture 200 of FIG. 2 includes describe participants process 202, schedule conference process 204, conduct conference process 210, select and configure equipment process 212, network I/O (i.e., input/output) process 214, provide notices process 216, equipment and data participants 218, monitor participant availability process 220, and reschedule or cancel conference process 222.

System architecture 200 is not restricted to particular details of any physical implementation. For example, any number of processors may perform the processes listed above. These processes may be implemented using conventional distributed processing technology (e.g., remote procedure call, client-server, or parallel processing). Such processors may be located centrally or grouped with instances of equipment 218. Processes 210, 212, and 220 may be performed in a processor of a hub. Processes 214, 216, and 222 may be performed in a processor of a hub. Data stores 206 and 208 may be separate or combined. A processor of a control station may perform processes 202, 204, 222, 214, and 216. In other implementations a first control station may perform process 202, a second may perform process 204, and a third (e.g., a self-service kiosk in a visitors' lobby) may perform an identification confirmation portion of process 210 and processes 214 and 216. In still another implementation, proprietary data and processes 203 are hosted on a central system, any number of enterprise conferencing subsystems 201 may support conference stations of the enterprise and the remaining processes may be hosted on a control station.

Data flows illustrated in FIG. 2 by arrows may be implemented by common access to memory or storage of one processor, or by access, bus, or network links between processors.

Generally, a conference participant station designed for use by an individual employs one set of equipment 240-246 for exclusive use by one human participant. Such a personal conference participant station may provide exclusive use of (or a thread for) one of each of processes 210-216 and 220. All threads for one participant may be performed on a single processor to avoid supporting a multiple thread execution environment. Alternative implementations may host several threads for a number of personal conference participant stations on a single processor, for example, made part of a hub 108 serving stations 105-106.

Data used by processes of architecture 200 may be organized and stored in any conventional manner. Particular synergies are realized in systems according to various aspects of the present invention by storing participant locations and rules 206 on storage maintained for use primarily by supervisors (e.g., access and edit privileges), providing limited access (e.g., read only) to administrators, and providing barriers to access (e.g., no authorized means of access) by participants 116, 218 and coordinators 115. Additional synergies are realized by storing conference plans 208 on storage maintained for use primarily by administrators (e.g., access and edit privileges), providing limited access (e.g., read only) to coordinators 115, and providing barriers to access (e.g., no authorized means of access) by participants 116, 218.

Data storage may be centralized or distributed (e.g., mirrored, shadowed, redundant, or controlled by a directory service of the type marketed by Microsoft as Active Directory or by Novell as Network Directory Service). Distributed storage may include physical storage in any stations 102-106 and hub 108.

A describe participants process 202 maintains information about people, equipment, and data that may be designated as participants in one or more conferences. Such information may include suitable unique identification (e.g., name, serial number, path name), role of human participant, type of equipment for equipment participant, contact and other information to locate or make available the participant at a particular location, and rules for scheduling and conducting conferences. Describe participants process 202 may cooperate with storage for participant locations and rules 206 to perform all conventional functions of a database management system. Data from participant locations and rules 206 may be provided (e.g., to processes 204, 210, and 220) as a report, a response to a query, or by reference to a suitable index. Process 202 provides a conventional user interface for use by supervisors 113.

A schedule conference process 204 creates, revises, and deletes records stored in a database of conference plans 208 to establish a conference to be held at a date and time in the future. Conference plans may be maintained as a record of conferences completed (successfully through expected duration, or otherwise unsuccessfully) or cancelled. Rules referred to by process 204 from store 206 may limit participation in conference plans to described participants generally or to qualified participants (e.g., having particular attributes, prior registration, or approval). Qualification may be established by any conventional work flow or work group software. Process 204 provides a conventional user interface for use by administrators 114.

For each scheduled conference, conference plans 208 may include a unique conference identifier, a list of equipment (if any) needed at each site, station, or location; a list of participants and stations identifying which station each participant is to use (e.g., one or more participants at each identified station); a start date and time for the conference; an ending date and time for the conference; and status information posted by monitor participant availability processes 220. Conference plans 208 may include information for establishing links between participant stations via network 101, for example, identifiers (e.g., port numbers, network addresses, world wide port names) that define links, routes, gateways, and paths through network 101.

A conduct conference process 210 reviews conference plans 208 and when the start time of a conference approaches does the following in any order and during any suitable period of time: (a) identifies equipment and configurations to select and configure process 212 that may accomplish selection and configuration of equipment 218 via controller 250; (b) directs network I/O process 214 to establish or assure links 101 via network I/O circuits 232 will be effective for the conference; (c) confirms identification of human participants prior to allowing participation; and (d) directs provide notice process 216 to provide notice of the upcoming conference to a coordinator 115 or to a participant 116. These functions may be distributed for performance by processors near the participants or participant stations. These functions may be performed in any combination by several separate processors (e.g., function (b) on a processor separate from function (c)). Cooperation between processors may effect security (e.g., access limits, fire walls, encryption). Notice may be provided by a computer screen display, via network 101 (e.g., email), or by a printer 234. Preferably, notice is provided by a printed report (e.g., all conferences for the day, or all conferences for a particular station for a period of time), a printed directive (e.g., a handbill, receipt, or ticket), or a message as discussed above. Notice conveys information to a coordinator or an individual human participant as to where to go and what station to use to be part of a particular conference to which the participant was scheduled to attend.

A monitor participant availability process 220 performs tests on equipment 218 and reviews data in participant locations and rules 206 to determine whether data and equipment participants and human participants (collectively 116 and 118) will be available to participate in a conference according to a conference plan 208. In the event that any participant will be, is, or becomes unavailable, monitor participant availability process 220 posts status in participant locations and rules 206 and/or conference plans 208. Equipment may be determined to be unavailable if a signal line from the equipment has an unsatisfactory signal on it during a test period. For example, the following are unsatisfactory: player 238 provides no signal, microphone 240 provides too much noise or no signal (e.g., open circuit), camera 244 provides no sync, too much noise, or no signal (e.g., open circuit), or a file of data store 248 does not exist or cannot be accessed.

A reschedule or cancel conference process 222 responds to status posted by monitor participant availability processes 220 to detect a planned conference that should be rescheduled (e.g., one or more participants are unavailable). Rescheduling may be accomplished prior to the beginning of a conference or during a conference. When a station (or a part of a station, e.g., a data or equipment participant) malfunctions, the station may be rendered unavailable until repaired. All conferences associated with the station until a predicted time the station will return to service may be rescheduled to use an alternate station. Preferably an alternate participant (human or equipment) will be located convenient to the affected human participants. Convenience may be assessed in terms of a forecast allowance of time to change locations of the participant to the desired location according to the rescheduled conference. If no suitable alternative is available at the desired rescheduled conference time, the original conference may be cancelled with notice provided to affected users 113-116.

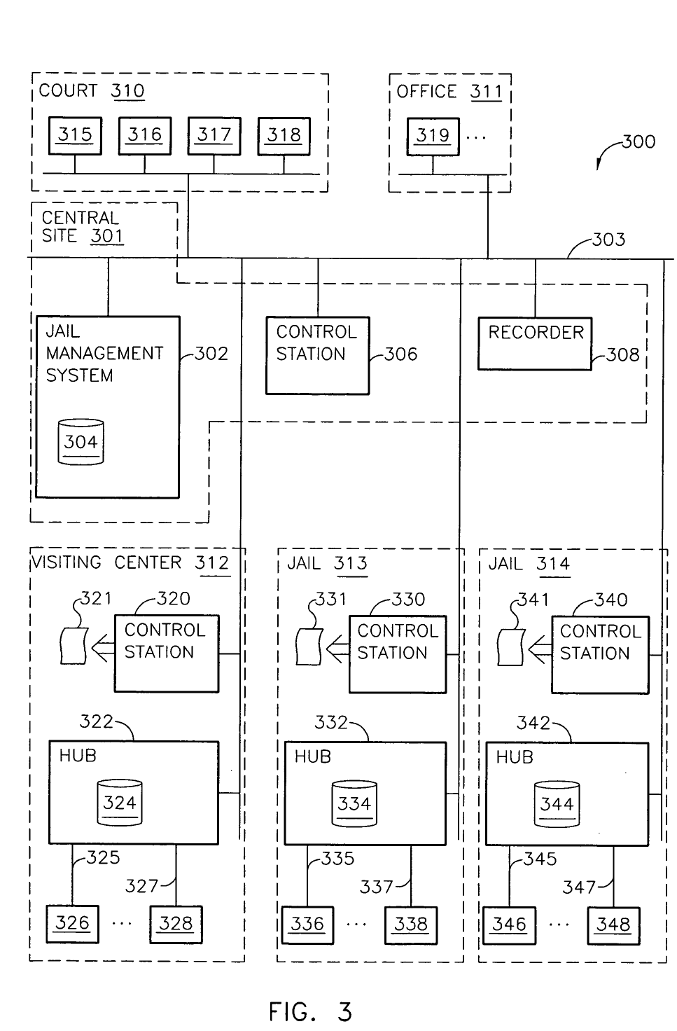

A video conference system according to system architecture 200 provides reliable video conferencing involving prisoners. For example, prisoner visitation system 300 of FIGS. 2-4 includes stations at six sites: central site 301, court 310, office 311, visiting center 312, jail 313, and jail 314. Each site of system 300 includes numerous stations organized within a physical boundary (e.g., a court room 310), organized within a political organization (e.g., a department of an office 311), organized for convenience of installing system components (e.g., different security conditions for visiting center 312 and for jail 313), and organized for achieving system budgets or efficiencies with hubs in particular areas. Alternate implementations of system 300 include any number of sites and any number of stations per site. Sites may be in separate physical locations.

Central site 301 includes jail management system 302, conference control station 306, and recorder 308. Network 303 provides conventional digital communication among sites using Ethernet and ATM technologies as discussed with reference to network 101 above. Broadband technology for network 303 is preferred.

A jail management system includes any system that provides prisoner information regarding the identity and location of prisoners. A jail management system may provide information regarding limits (e.g., rules) on whom the prisoner may confer with. Further, a jail management system may include any other data suitable for operating a jail, prison, or penitentiary. For example, jail management system 302 includes a conventional computer system (coupled for digital communication via network 303) and a database 304. The computer system may be operated by a supervisor to operate any conventional database management system governing database 304 including a user GUI for entry/edit of data stored in database 304, for defining queries, and for viewing and reporting data of database 304. Database 304 in one implementation includes tuples (e.g., associations of data item values) as described in Table 1.

TABLE 1

| Tuple | Description |
|---|---|
| prisoner name, prisoner location, | Current location; itinerary of planned other locations; |
| date-time | history of past locations; may include alternate future |
| | locations for the same prisoner name and date-time; |
| prisoner name, visitor name, | A permitted activity may include a conference (or |
| permitted activity, beginning date- | visit) of a type defined by rules; requested or approved |
| time, ending date-time | visitors are indicated for each particular prisoner; |
| | visitor may be identified by a role as family member, |
| | friend, business associate, clergy, and legal counsel; |
| | particular visitors may have limitations on privileges |
| | to visit another particular prisoner; |
| visitor name, contact information, | Facilitates contacting visitor about grants, |
| description of visiting rights for next | withdrawals, and use of visiting rights |
| period, description of visiting rights | |
| remaining in the current period, | |
| definition of period | |
| prisoner name, date-time of report, | Facilitates changes in visiting privileges |
| date-time of incident, comment on | |
| behavior | |
| visitor name, date-time of report, | Facilitates changes in visiting rights |
| date-time of incident, comment on | |
| behavior | |

Jail management system 302 implements process 202 and participant location and rules 206 as discussed above.

Conference control station 306 performs functions discussed above with reference to conference control station 102. Conference control station 306 may be operated by an administrator as discussed above.

Recorder 308 may be a multichannel recording device for recording any number of simultaneous conferences in whole or in part. One or more channels of recorder 308 may be specified as participants in a conference. If channels are not available, substitute channels may be used as a consequence of rescheduling as discussed above. Recorder 308 may provide an archive for conference recordings made at other sites. Transfer of data to recorder 308 may be automatic according to a scheduled backup operation or as requested by a person authorized to determine whether an archive is desirable. Authorizing may be limited by a rule to a person that was a participant of the conference recording to be archived.

In an alternate implementation, a hub (e.g., like 322) and one or more participant stations are used in place of recorder 308. The hub having a built-in recording capability also supports monitoring of recorded material (e.g., for review, or during recording). Monitoring may be accomplished covertly in any conference, for example, by one or more of a group of intelligence officers. Covert recording (e.g., of clergy) or monitoring may be scheduled on control station 306 when permitted by or consistent with suitable records of jail management system 302 (e.g., a flag associated with a conference or human participant set in response to a warrant, a court order, or a grant).

Court 310 includes conference participant stations for a judge 315, prosecutor 316, defense attorney 317, and witness 318. A projection system and public address system may be equipment participants to facilitate attendance by a jury.

Office 311 includes any number of general purpose stations 319. Each station may be implemented with a conference participant station or a conventional desktop computer, operating system, software, and peripherals capable of functions supporting a conference participant as discussed above. A general purpose station may be used by a supervisor, an administrator, or a participant. As an administrator, the user may unobtrusively observe or record a video conference (e.g., for security, operations research, training, or system management purposes). With suitable software and peripherals, a general purpose station may also be used as a source of programming to be provided during the video conference; or, as a recorder of any portion of a video conference.

Visiting center 312 includes conference control station 320 coupled to network 303, any number of participant stations 326, 328; and hub 322 that couples participant stations to network 303. Hub 322 includes database 324, generally for operations local to visiting center 312. Control station 320 may be used by an administrator or a coordinator to make or revise reservations, issue notices 321 regarding a conference, or perform local system management functions. A hub may support a local terminal with GUI (not shown) that may be used in place of control station 320 to reduce reliance on network 303.

Jail 313 (and 314) includes any number of conference participant stations 336, 338 (346, 348); hub 332 (342) that couples stations to network 303; and conference control station 330 (340) that is also coupled to network 303. Hub 332 (342) includes a database 334 (344) for operations local to jail 313 (314). Control station 330 (340) may be used by an administrator or a coordinator to make or revise reservations, issue notices 331 (341) regarding a conference, or perform local system management functions. Each hub 332 (342) may support a local terminal with GUI (not shown) that may be used in place of control station 303 (340) to reduce reliance on network 303. In an alternate implementation, some of conference participant stations 336-338 are located in a secure area of the jail for use by visitors. Visiting center 312 may be omitted.

A conference may include any number of stations at any number of sites. The stations, participants, and any other system capabilities reserved for a conference may be revised before a conference. Suitable revisions to stations, participants, and any other system capabilities in use or reserved for a conference may be revised during a conference. A new conference may be reserved or begun that is modeled in full or in part after a reserved conference, a conference that is in progress, a conference that has been cancelled, or a conference that has been completed. Station functions may be limited according to rules associated with the conference.

For example, a video conference may include prisoners at jails 313 and 314 using station 336 and 348 in a video lineup for identification by a witness at station 318, with review and participation by attorneys at stations 316 and 317, a judge at station 315, and an expert at station 319. Stations 336 and 338 may be limited to receive audio only from station 315, to receive no video, and to transmit video without audio.

In another example, an attorney, clergyman, or family member may arrive at visiting center 312, be directed to a station 326 by notice 321, and confer in a series of scheduled conferences with prisoners in jails 313 and 314. Each conference may include notice 331 to a guard who directs or escorts a prisoner to a particular station 336 without having to transport the prisoner outside the jail (or outside a cell block or cell where a particular station has been installed). If the participant station is located in a cell, the guard may merely assure that the prisoner is aware of the conference and how to participate.

In a preferred embodiment, conference participant stations 326, 328, 336, 338, 346, and 348 are implemented for maximum mechanical durability and minimum complexity to reduce the cost of expected vandalism and aggressive behavior of participants. In such an implementation, each station includes a monitor (e.g., providing an SVGA interface), a camera (e.g., providing a USB interface), a microphone (providing an analog line level interface), a speaker (providing an analog interface for setting volume at the hub), and a hook switch (e.g., a proximity switch having no moving parts) for the microphone-speaker hand set. Each participant station may be connected by separate cables (e.g., point-to-point) to each interface of a hub. In one implementation a hub supports up to 20 conference participant stations. Conference participant stations may be arranged one per cell or site; or, in groups of stations per site serving a large number of visitors (e.g., at site 312) or prisoners (e.g., at site 313 and 314) with minimum staff to coordinate use by visitors (e.g., a receptionist) and prisoners (e.g., a unit guard).

A hub may perform network bridge and gateway functions implemented using circuits for signal switching (e.g., discrete audio and video signals; analog, serial, or parallel digital signals) and circuits for packet switching. Packet switching (e.g., as used with network 303) allows each hub to operate as a slave of a control station; or as an initiator for peer-to-peer communication among hubs. Peer-to-peer communication may facilitate monitoring (e.g., aggregating availability results to determine whether to cancel a conference) and rescheduling (e.g., if a suitable alternate participant is served under another hub) as discussed above. Analog switching may be used with analog tests to simplify monitoring functions discussed above.

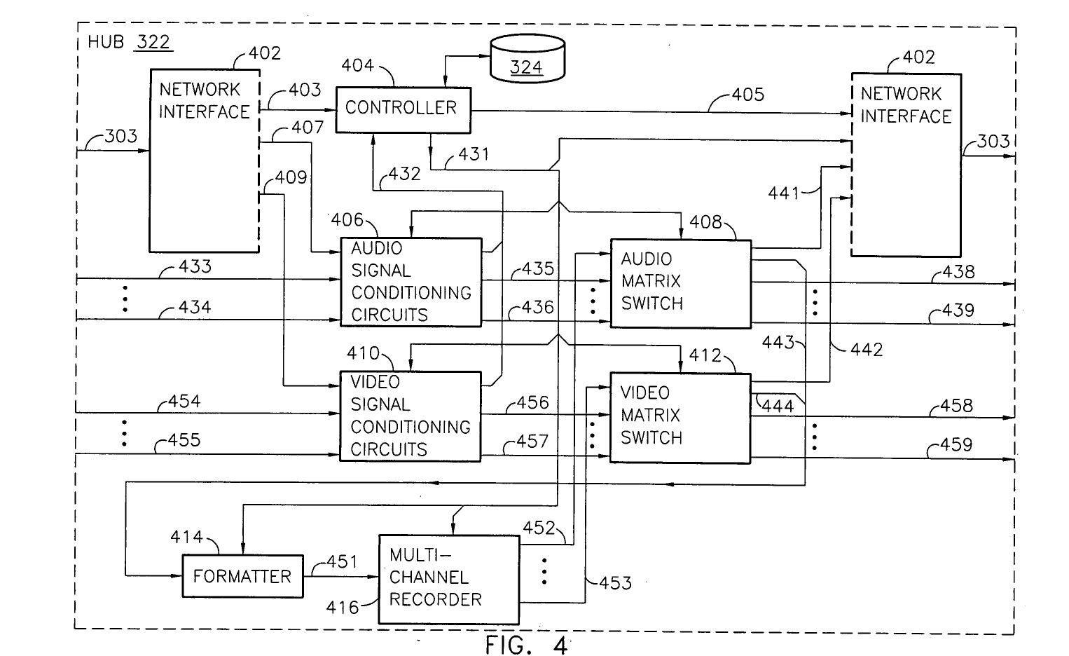

For example, hub 322 of FIG. 4 includes network interface 402, controller 404, audio signal conditioning circuits 406, audio matrix switch 408, video signal conditioning circuits 410, video matrix switch 412, formatter 414, and multichannel recorder 416. Hubs 334 and 344 may be of the same type.

Network interface 402 implements functions discussed above with reference to network I/O process 214 and network I/O hardware 232. Input packets from network 303 are parsed and provided by network interface 402 to controller 404 on line 403 as commands and data (e.g., from a conference control station, or peer hub controller). Controller 404 provides commands and data (e.g., replies, status, and commands to peers) on line 405 to network interface 402 for submitting as packets on network 303. Both input and output packets may include network addresses. Input packets not bearing an address corresponding to this hub are ignored. Output packet addresses may specify the intended recipient (e.g., hub or control station). Network interface 402 may include digitizing circuits for converting analog signals on lines 441 to digital to be included in packets conveyed on network 101. Network interface 402 further includes digitizing circuits for converting video signals on lines 442 to digital to be included in packets conveyed on network 101.

A controller 404 may perform processes in cooperation with database 324 corresponding to schedule conference process 204, conduct conference 210, select and configure equipment process 212 (e.g., typically limited to equipment at the same site as the hub), network I/O process 214, monitor participant availability process 220 (e.g., typically limited to participants at the same site as the hub), and reschedule or cancel conference process 222 (e.g., initiation action to reschedule participants among same site stations and equipment, and requesting cancellation to be accomplished by a control station that may have efficient access to information to determine whether additional alternatives should be considered before effecting a cancellation). Some monitoring functions may be accomplished in hardware (e.g., part of signal conditioning circuits). By distributing portions of the scheduling and rescheduling processes among hub controllers, reservations for conferences are made and maintained using scalable and distributed computing techniques. Controller 404 may include database management functions to synchronize the data kept on database 324 with data kept on peer hub controllers, control stations, and jail management system 302.

Controller 404 provides control signals 431 to implement select and configure equipment process 212. Control signals 431 may be any conventional signals including a parallel data bus, a serial data bus, and dedicated discrete control lines. Control signals 431 are directed to network interface 402, audio signal conditioning circuits 406, audio matrix switch 408, video signal conditioning circuits 410, video matrix switch 412, formatter 414, and multichannel recorder 416. Control signals 431 to network interface 402 may specify packet switching and routing functions to implement any data path (e.g., a link) between a station 326, 328 and network 303. Typically, such a path includes (a) an input port for receiving packets to be presented on a speaker or a video monitor; and (b) an output port for sending packets developed from a microphone or camera. Implementation of a path includes opening an input port, opening an output port, and associating the ports with signals of a particular station. For example, a first network address (e.g., a physical port number, an IP address) is associated with lines 438 and 458 to station 326. The same or a second network address is associated with lines 433 and 454 from station 326. When an input port is closed, packets bearing the first network address are ignored by this controller. When an output port is closed, no further packets bearing the second network address are prepared or sent. Typically, ports are opened at a conference start time, remain open for one conference, and are closed when the conference terminates for any reason.

Each station 326 provides an input audio signal 433, and an input video signal 454. Each station 326 receives an output audio signal 438 (e.g., combined audio from all stations of the conference, or audio as directed from time to time by rules of the conference) and an output video signal 458 (e.g., one camera image, a formatted picture-in-picture formed from video from several stations of the conference, or screens as directed from time to time by rules of the conference).

Status signals on line 432 are input to controller 404 for determining availability of stations 326, 328. For example, each conference participant station 326 (328) provides an analog audio signal 433 (434) from a microphone (e.g., a line level signal). Audio conditioning circuits 406 may include a comparator for each line level signal, comparing the signal amplitude to a minimum threshold value (e.g., a wide band, band limited, or signal to noise evaluation). If the signal received on line 433 (434) is below the threshold, the associated station is reported unavailable on line 432. Each conference participant station 326 (328) provides a signal 454 (455) from a camera (e.g., scanner output signals and sync signals in any conventional format) that may be analyzed for suitable variation or consistent signal attributes to distinguish “weak or no picture”, “weak or no synchronization”, “weak or no color signal”, or “too much noise”. If any of these conditions persist, video conditioning circuits 410 may report on line 432 that the camera of the associated station is unavailable.

For each input channel 433 (434), output conditioned signals 435a and 435b (436a and 436b) are provided to audio matrix switch 408. Audio signal conditioning circuits 406 may provide an audio signal 435a delayed with respect to audio signal 433 to synchronize with a video signal on line 433 by introducing a suitable signal conditioning delay in accordance with control signals 431. In addition, any conventional audio signal conditioning may be implemented (e.g., amplification, band limiting, equalization). Audio signal conditioning circuits 406 also provide combination audio signal 435b that includes audio 407 received via network 101 (e.g., addressed to a particular port of circuit 406) generated from other participating stations of the conference.

Audio matrix switch 408 includes a conventional crossbar switch for coupling any input line 435 to any output line 438-439 in accordance with control signals 431. The conditioned audio signal 435a may be routed to network interface 402 for use in audio conditioning circuits of participating stations (e.g., there forming a composite audio signal of all stations of the conference). The combination audio signal 435b may be routed to one or more participating stations in accordance with control signals 431. Either or both signals 435a and 435b may be routed to channels of formatter 414 in accordance with control signals 431.

For each input channel 454, output conditioned signals 456a and 456b are provided to video matrix switch 408. Video signal conditioning circuits 410 may provide a video signal 456a via any conventional video signal conditioning (e.g., amplification, band limiting, color balanced, special effects). Video signal conditioning circuits 410 also provide combination video signal 456b that includes video 409 received via network 101 (e.g., addressed to a particular port of circuit 410) generated from other participating stations of the conference.

Video matrix switch 412 includes a conventional crossbar switch for coupling any input line 456 to any output line 458-459 in accordance with control signals 431. The conditioned video signal 456a may be routed to network interface 402 for use in video conditioning circuits of participating stations (e.g., there forming a composite video signal of all stations of the conference). The combination video signal 456b may be routed to one or more participating stations in accordance with control signals 431. Either or both signals 456a and 456b may be routed to channels of formatter 414 in accordance with control signals 431.

For each video conference to be recorded, up to the limit of the number of channels of multichannel recorder 416, formatter 414 composes a program representing a selection and combination of audio and video signals using conventional signal formatting techniques such as picture in picture, selection of the picture corresponding to the speaker, and summation (or maintaining separate) audio signals that have been synchronized to the corresponding video image of the speaker. Each such program is formatted in accordance with control signals 431 and provided to multichannel recorder 416 on line 451.

Multichannel recorder 416 accepts formatted signals on line 451 and records such signals on channels designated by control signals 431. More than one channel may be designated for one teleconference. Playback of one or more channels (e.g., for one or more video conferences) via lines 452-453 may be directed through matrix switches 408 and 412 for presentation on any station of system 300. Any conventional removable or nonremovable media may be used.

Playback is typically scheduled as a conference involving one or more particular recorder channels and at least one participant station for viewing the playback. Playback may also be part of a presentation in another video conference by including one or more channels of recorder 416 as equipment participants. If the media is separated from the recorder, a playback conference may include a data participant by specifying an identifier of the recording for playback (e.g., identified by a conference identifier, a recorded media identifier, or a filename).

A method for making a conference reservation according to various aspects of the present invention records one or more tuples described in Table 2.

TABLE 2

| Tuple | Description |
|---|---|
| Conference identifier, start | The system may assign a conference identifier to facilitate |
| date-time, end date-time, | identifying numerous tuples below with the same conference |
| status | identifier. Any specification of the beginning and duration of |
| | the conference may be made. The duration of the conference |
| | may be specified or calculated. In one implementation, it is |
| | assumed that all participants participate for the entire duration of |
| | the conference, one duration being specified for all. In an |
| | alternate implementation, each participant participates for a |
| | specified duration (i.e., respective start and end times for each |
| | participant) and the conference end date-time is the latest of all |
| | participants. |
| Conference identifier, | A participant may be a person, a piece of equipment, or a data |
| participant identifier, | item. When a human participant is identified with the same |
| participant needed at | location as an equipment participant, the person may be assumed |
| location, participant | to be operating (perhaps exclusively) the equipment. For |
| current location, transit | example, to assign a person to a single user conference |
| time allowance, contact | participant station, the person tuple will have the same needed at |
| information for use to | location identifier as the station tuple. Current location (e.g., for |
| notify participant | inmates) may be tracked and available to the process that |
| | schedules conferences. If omitted, transit time allowance may |
| | also be omitted. The times at which notices are provided may |
| | account for a transit time allowance. Notice may be given to |
| | someone other than the participant (e.g., a coordinator, escort, |
| | guard). |
| Conference identifier, | Rescheduling of a conference may be initiated on condition that |
| participant identifier, | the unavailability of one or more high ranking participants |
| participant rank | makes the conference ineffective. In one implementation all |
| | participants are considered critical and individual rank is |
| | omitted. In another implementation, lower rank assigned to an |
| | observer allows the observer to be unavailable without initiating |
| | rescheduling. In another application, if a quorum of same rank |
| | participants are available, the conference will not be |
| | rescheduled. |
| Conference identifier, | Availability of a conference participant may be tested with |
| participant identifier, last | criteria suitable for the type or identify of a participant. For |
| tested date-time, test | example, the equipment of a conference participant station may |
| procedure | be tested for its ability to produce suitable audio and video |
| | signals. |
| Participant identifier, | This tuple may be used for defining constraints for any function |
| business rule, parameters | of a conference system according to various aspects of the |
| for evaluating business | present invention. For example, a business rule in this context |
| rule | includes any test that affects accepting a request for scheduling, |
| | scheduling, notifying, testing unavailability, or rescheduling. |
| | The business rule may be expressed in any conventional manner |
| | (e.g., a pointer or suitable identifier of a script or program). The |
| | business rule may be omitted from the tuple if implied by the |
| | business rule parameters. Parameters may include one or more |
| | descriptors of the participant, one or more limits to be applied, |
| | or parameters defining how the business rule is to be applied |
| | (e.g., when to re-evaluate, consequences of particular results of |
| | applying the rule, or exceptional handling procedures). The |
| | business rule may be evaluated prior to accepting a request to |
| | schedule a conference, or evaluated one or more times prior to |
| | the conference. |

A method for scheduling a video conference may include determining locations where conference participants are needed to participate in the conference; determining a period of time during which the conference will be held; determining a conference identifier; and storing one or more tuples as described in Table 2. Further, the method may include any one or more of the following operations for assuring that a conference will proceed with suitable participants during a period of the conference by: (a) notifying the participant, an agent for the participant, or a coordinator to cooperate with the participant; (b) allowing transit time for the participant; (c) testing the participant's availability prior to or during the conference; (d) rescheduling an alternate participant prior to or during a conference if an initial participant is expected to be unavailable or becomes unavailable during the period for the conference; (e) rescheduling the conference if the available participants do not satisfy a rule; (f) notifying participant(s) affected by the rescheduling; and (g) coordinating the co-location of participants (e.g., directing a human participant to a particular conference station equipment participant) prior to or during the conference. When scheduling is accomplished with cooperation of processors coupled for communication via a network, each scheduling process may accomplish one or more of the operations discussed above and communicate requests or results to the other processors.

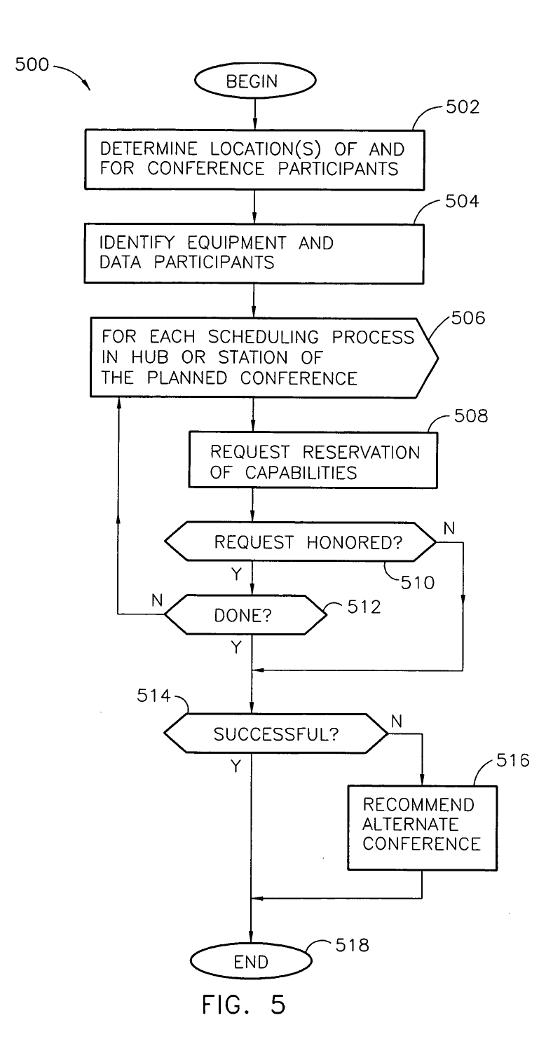

For example, method 500 of FIG. 5 proceeds as follows. Location information (e.g., current nonconference location, planned conference location, location for availability testing, location for notification, location for coordination such as a lobby) is determined (502) of or for intended conference participants. Equipment and data for the conference is identified (504) to the conference. For each scheduling process (e.g., in a hub, control station, or general purpose station) related to the conference and planned capability (e.g., participant, network infrastructure such as capacity, network addresses, channel numbers, port numbers), a reservation of capabilities is requested (508); a determination is made (510) whether the request is honored; if not honored the reservation is considered unsuccessful; and if honored, each other (512) scheduling process and planned capability is considered. After considering (514) a dishonored request or after considering all capabilities, requesting is considered successful, the scheduling operation is considered complete (518); and otherwise, a recommendation is made (516) for a conference involving an alternate capability (e.g., different time, different location, different participant). The determination (510) may employ any conventional scheduling algorithm or an algorithm of the type discussed below.

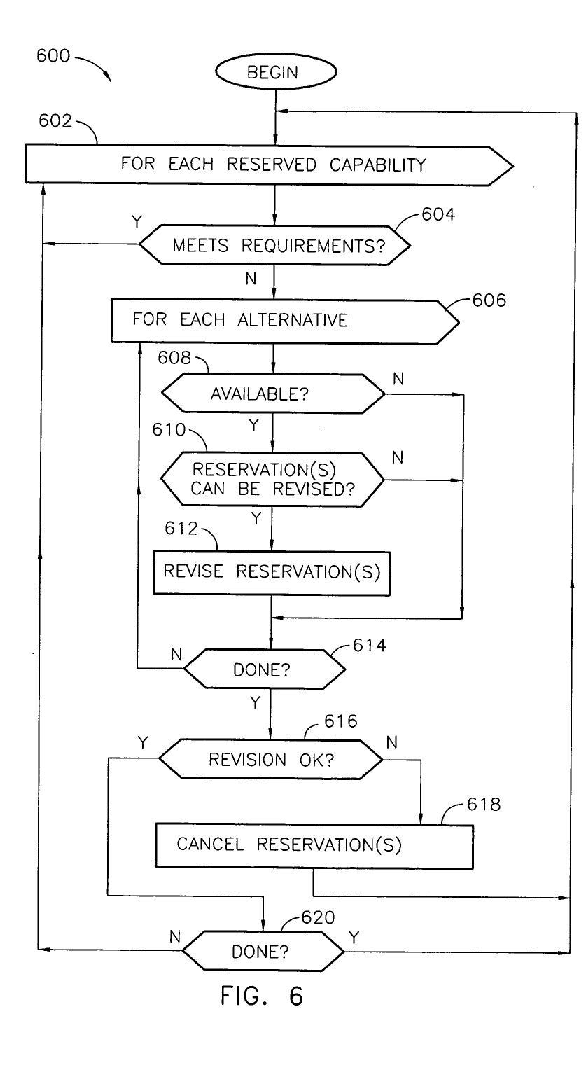

Methods according to various aspects of the present invention increase the likelihood that a participant will be available for a conference. For example, method 600 of FIG. 6 proceeds as follows. For each (602) scheduled participant or capability related to a particular conference: it is determined (604) whether the participant or capability meets a rule that has been associated with the participant or capability (e.g., by reference in a tuple, by implication from type of participant or capability, or as a consequence that participants and capabilities are generally subject to the rule); if so the next one is considered (602); if not, alternatives are considered (606); if a schedule revision is completed satisfactorily (616), the next participant or capability is considered until all scheduled participants and capabilities related to a particular conference have been considered (620); otherwise one or more conferences are cancelled, freeing all participants and capabilities for the conference period (618). Alternatives are considered (606) as follows: it is determined whether the alternative participant or capability is available (608) at the time needed for the conference; if not, another alternative is considered until all have been considered (614); if so, it is determined whether the subject conference schedule can be revised (610) to include the alternate; if so, the schedule is revised (612); and if not, another alternative is considered until all have been considered (614). More than one conference schedule may be affected by a determination that a particular participant or capability is unavailable (608). If the same participant or capability is included in other conferences, revision to those conference schedules is considered (610) and accomplished (612). By revising one conference schedule (e.g., canceling the conference), alternatives become available for consideration.

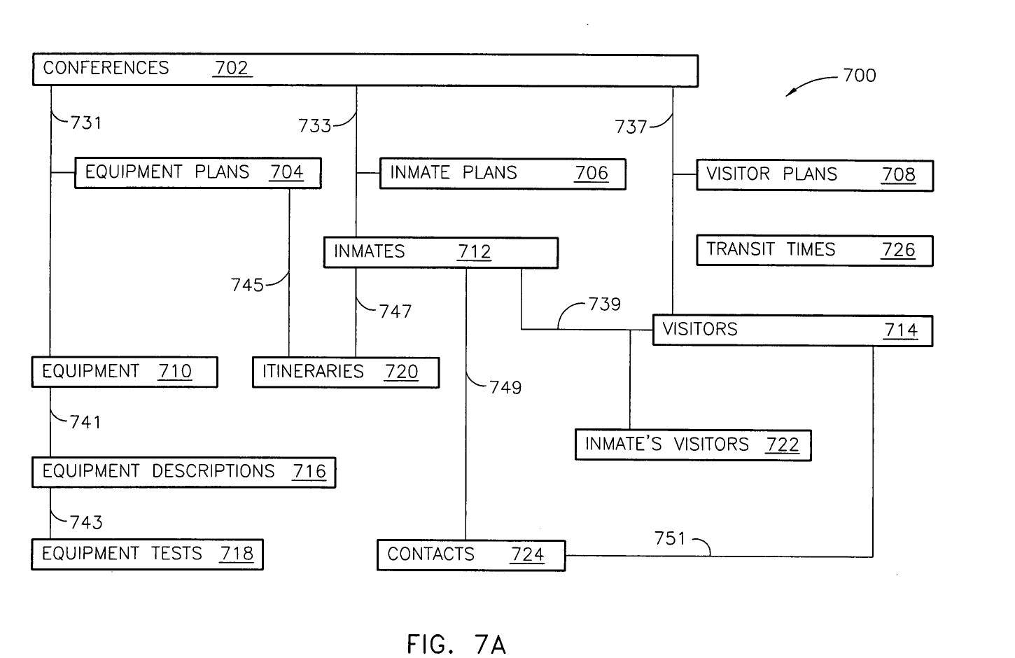

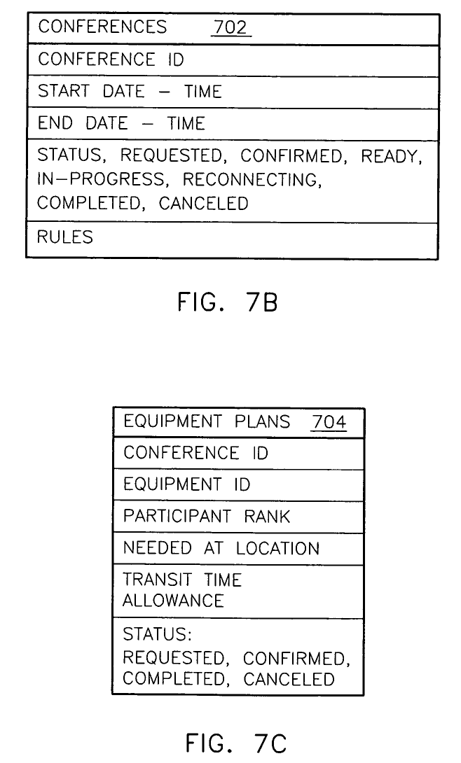

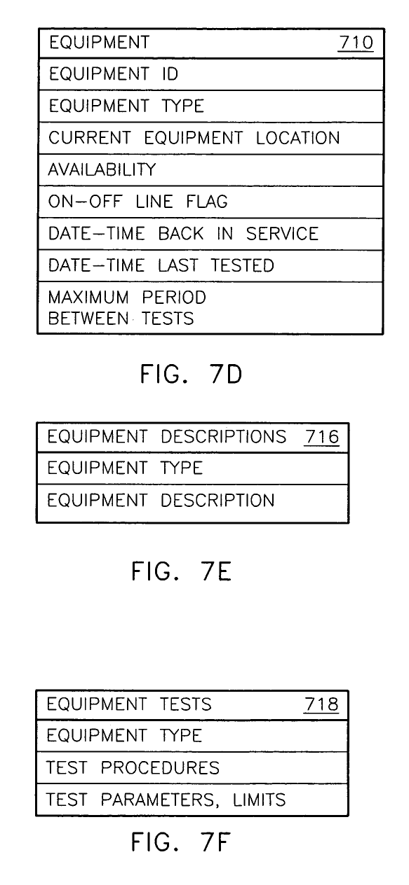

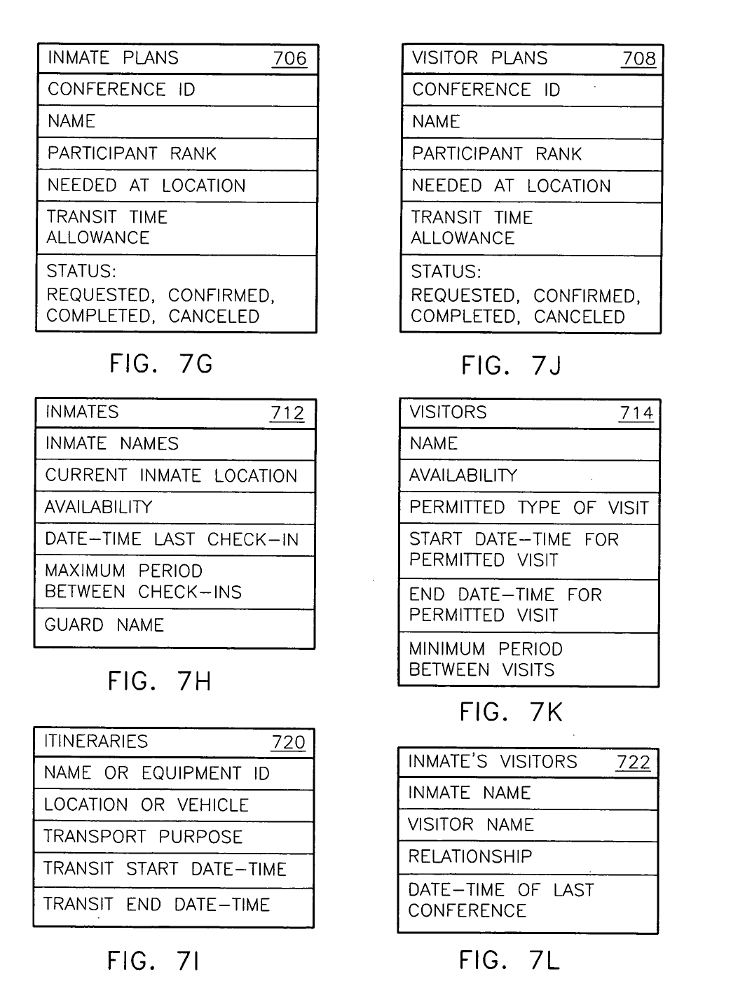

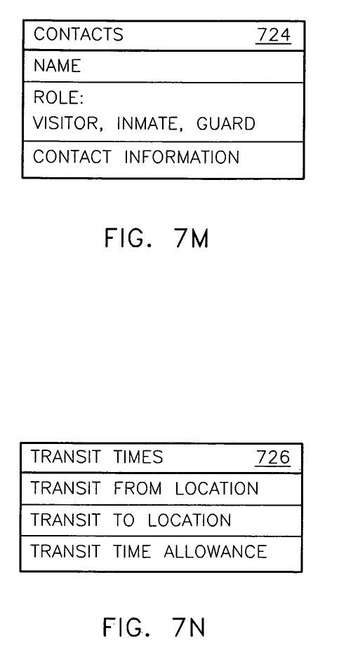

A data structure according to various aspects of the present invention may be referred to by any process that schedules, conducts, monitors availability, or reschedules conferences, to complete an operation of such a process, as discussed above. A database may include lists of records having the same structure (e.g., values for the same purpose indicated by a field name). Any two or more values of a data structure (e.g., a record) comprise a tuple by implementing an association (e.g. a relationship) between the values. For example, a database 700 of FIGS. 7A-7N for use by system 300 implements participant locations and rules 206 and conference plans 208 and may be stored in part on jail management system 304, control station 306, and stores 324, 334, and 344 as discussed above. Database 700 includes lists-of records for conferences 702, equipment plans 704, inmate plans 706, visitor plans 708, equipment 710, inmates 712, visitors 714, equipment descriptions 716, equipment tests 718, itineraries 720, inmate's visitors 722, contacts 724, and transit times 726. Fields of the records of each list are described in Table 3.

TABLE 3

| Field | Description |
|---|---|
| Conference ID | A unique identifier for every conference past, present, and future. |
| | Records may be maintained in database 700 for past conferences for |
| | reference and for use as patterns for the simple scheduling of similar |
| | new conferences. |
| Conference start | The period of a conference may be stated as a start time and duration or |
| date-time | as a start time and an end time. |
| Conference end | The period that a conference was or will be held terminates with the end |
| date-time | date-time. |
| Status: Requested | The associated conference ID identifies a conference that has been |
| | requested but has not yet been confirmed because the status of a |
| | participant is not yet confirmed. When an administrator posts a |
| | conference record in 502 with associated equipment plans, inmate plans |
| | and visitor plans, requests (508) may be sent to other processes (e.g., |
| | hubs) and the results (510, 514) posted in due course. A requested |
| | conference that is not confirmed in a reasonable time may be withdrawn |
| | or cancelled. |
| Status: Confirmed | The associated conference ID identifies a conference that has all of its |
| | participants confirmed. A participant is confirmed if it is likely to be |
| | available at the time and location needed. |
| Status: Ready | The associated conference ID identifies a conference that has passed a |
| | date-time in advance of its conference start time and a suitable number |
| | of participants have been tested as available. If sufficient high rank |
| | participants are not available, the conference status will proceed from |
| | confirmed to cancelled. |
| Status: In-progress | The associated conference ID identifies a conference that is being held |
| | among some or all of its scheduled participants. |
| Status: | The associated conference ID identifies a conference in which a |
| Reconnecting | participant or capability became unavailable. Processes 220 and 222 |
| | may cooperate to reestablish availability of this participant or capability |
| | or reschedule an alternate participant or capability into an ongoing |
| | conference. Such rescheduling is accomplished without interfering with |
| | the ongoing conference. For example, if a first single user participant |
| | station goes unavailable (e.g., suddenly no audio signal from the |
| | station) and a nearby second single user participant station is available, |
| | a local coordinator may receive notice to direct the human participant to |
| | the second station. |
| Status: Completed | The associated conference ID identifies a conference that was started. |
| | The conference for any reason may not have run to its end date-time. A |
| | completion record may be added to database 700 in an alternate |
| | implementation for collecting quality control information such as a |
| | reason for not using the entire allotted time. |
| Status: Cancelled | The associated conference ID identifies a conference that was not held |
| | at all. Therefore, no recording is associated with this conference ID in |
| | any event. A cancellation record may be added to database 700 in an |
| | alternate implementation for collecting quality control information such |
| | as a reason for the cancellation. |
| Rules | Information stored in the form of data (e.g., equipment settings, |
| | addresses, or permissions) or procedural constructs (e.g., conditions, |
| | statements, scripts, entry points for processes) that may specify initial |
| | configurations, permitted operations, or revisions to the conference for |
| | one or more participants. |
| Equipment ID | A unique identifier of a piece of equipment that may be used in a |
| | conference. A station may include several equipment IDs to identify |
| | portions of the station that are unavailable. A station (e.g., a portable |
| | station) may have a single equipment identifier for simplicity of |
| | scheduling. |
| Availability | A rule or reference to a list of dates and times that the participant is |
| | available for a conference (e.g., 728, 730, 732). Scheduling and |
| | rescheduling processes may refer to availability as defined by this field |
| | value (and possibly to conferences that are already scheduled for this |
| | participant that are not reflected in this availability field value) to |
| | determine availability for a particular conference request. |
| Participant rank | Rank may be a numeric value on a scale with higher numbers indicating |
| | a stronger need to participate in the conference and lower numbers |
| | indicating participation is less important, perhaps immaterial to the |
| | conference. Used, for example, to determine whether unavailability |
| | without an available alternate should effect cancellation of the |
| | conference. |
| Needed at location | The location where a participant participates in the conference. If |
| | multiple participant stations are located in a group (e.g., visitors center), |
| | the needed at location specifies one of the participant stations. A station |
| | may be specified by a physical location and by a network address. The |
| | network address may be the current address associated with the physical |
| | location of the station (e.g., one or more addresses resulting from a |
| | fabric, port, process, or user log-in operation). |
| Transit time | An amount of time allowed for a participant to be made ready to |
| allowance | participate in a conference. Transit time allowance may account for |
| | time for equipment tear-down and set-up, transportation, escort, and |
| | passage through intervening check points. May result from a lookup on |
| | transit times 526 between a from and to location. Used for example to |
| | reschedule a participant to an alternate station if the originally |
| | scheduled station becomes unavailable. In this example the transit time |
| | would be the time from the original station location to the alternate |
| | station location. If a prisoner must be escorted from the prisoner's |
| | current location to the location of the conference, transit time allowance |
| | may be used to calculate a suitable time for providing a final notice to |
| | the escort. Transit time is accommodated during scheduling and may be |
| | the basis for denying a request. Changes in transit time for a conference |
| | participant may give rise to rescheduling the provision of notices or |
| | rescheduling conferences. |
| Equipment type | Used to select alternatives. |
| Current equipment | Locations may be specified on a grid, as a unique named location(e.g., |
| location | landmark), or as “with” a second equipment identifier. |
| On/Off line flag | Equipment is on-line when it is available and is off-line when awaiting |
| | or undergoing repair. |
| Date-time back in | Equipment that has become unavailable may be accorded a date and |
| service | time estimate of when it can be relied upon for scheduling future |
| | conferences or used as an alternate in future conferences. |
| Date-time last | The difference between the date-time last tested and the date-time of a |
| tested | future conference may trigger a test to be run. |
| Maximum period | Equipment may be tested in proportion to the extent of reliance on the |
| between tests | equipment. No interfering tests may be frequent during a conference. |
| | A business rule may revise this value based on any combination of |
| | indications of reliance on a particular piece of equipment. |
| Equipment | Equipment of the same type may have reference information associated |
| description | with it to indicate factors affecting its reliability, for example, make, |
| | model, year purchased, hours in use, service and repairs. |
| Test procedures | Used to perform a test. The test procedure may automatic or manual: |
| | built-in, a pointer to a script, a program, a document for a manual test. |
| Test parameters, | Parameters include settings and configuration for making a |
| limits | measurement of a test variable to be compared to a limit. Limits |
| | include threshold values for tested signals define pass fail conditions. |
| Name | A unique identifier for a person. Where the person's given name is not |
| | unique, any additional identification may be used in addition or in place |
| | of the given name. |
| Current location | For a prisoner, the location of the last check in. For equipment, the |
| | location where it is expected to be ready for transportation to an |
| | upcoming conference. |
| Date-time of last | The date and time when a check-in of the prisoner was completed |
| check-in | successfully. |
| Maximum period | Different types of confinement may allow variation in the period |
| between check-ins | between check-ins. If a check-in does not occur, the prisoner is |
| | unavailable. Notice of a conference is preferably provided to a |
| | coordinator at a suitable time prior to an expected check-in. |
| Vehicle | An identifier that serves as a proxy for a location. |
| Transport purpose | Purpose of being transported in a vehicle. |
| Transit start date- | Scheduled beginning of being transported by vehicle. |
| time | |
| Transit end date- | Scheduled ending of being transported by vehicle. |
| time | |
| Permitted type of | The prisoner's privileges for visitation may dictate the types of visits |
| visit | allowed. Further, the relationship of the visitor may restrict the types of |
| | visits allowed. For example, a contact visit may be permitted for a |
| | spouse and not permitted for any other visitor. Noncontact visits may |
| | be accomplished by video conference. |
| Start date-time for | Visitation according to the type of visit in this record may be prescribed |
| permitted visit | during a period of time. For example, contact visits may be planned to |
| | be restarted after disciplinary denial of such visits. |
| End date time for | The privilege to attend the type of visit in this record may be terminated |
| permitted visit | at a given end date-time. |
| Minimum period | Visits may be spread out in time (e.g., once in a month period). |
| between visits | |
| Relationship | The relationship between the prisoner and the visitor (e.g., attorney, |
| | clergy, father, daughter, friend). Relationship having a value of |
| | attorney or clergy may dictate that no recording of the conference is |
| | permissible. Lack of same may indicate that recording is required. |
| Date-time of last | For the prisoner and visitor of this record, this date-time serves as a |
| conference | comparison for testing whether the visit is permissible with reference to |
| | minimum time between visits. |
| Role | A participant's role may restrict scheduling or use as an alternate. May |
| | identify what records may bear the participant's name - all persons |
| | named on records of visitors must have the role of visitor. A person |
| | may have multiple roles, so as to permit conferences among prisoners. |
| Contact | Any conventional description of how to provide timely notice to a |
| information | person. |
| Transit from | Used to specify transit time. |
| location | |
| Transit to location | Used to specify transit time. |

When creating a request for a conference to be scheduled, records in several lists may be related by records added to plans. For each relationship of a particular conference record 702 and a particular equipment record 710 (e.g., to book the equipment to be used in the conference) there exists a description of the relationship as a record in equipment plans 704. For each relationship of a particular conference record 702 and a particular inmate record 712 (e.g., to book an inmate to attend a conference) there exists a description of the relationship as a record in inmate plans 706. For each relationship of a particular conference record 702 and a particular visitor record 714 (e.g., to book a visitor to attend a conference) there exists a description of the relationship as a record in visitor plans 708. For each relationship of a particular inmate record 712 and a particular visitor record 714 (e.g., to list a prisoner's permitted visitors) there exists a description of the relationship as a record in inmate's visitors 722.

A method according to various aspects of the present invention conducts a conference among peers. No one peer need initiate the conference. For example, network 101 may include an address for each station. Addresses may be included in conference plans 208 for reference by any conduct conference process 210. When a conference is to be conducted, each station (e.g., via cooperation of 210, 214, and 233) may begin monitoring packets according to addresses (e.g., a station's own address, and packets bearing an address of any participant in the conference). Each station may conduct the conference according to rules associated with the conference.

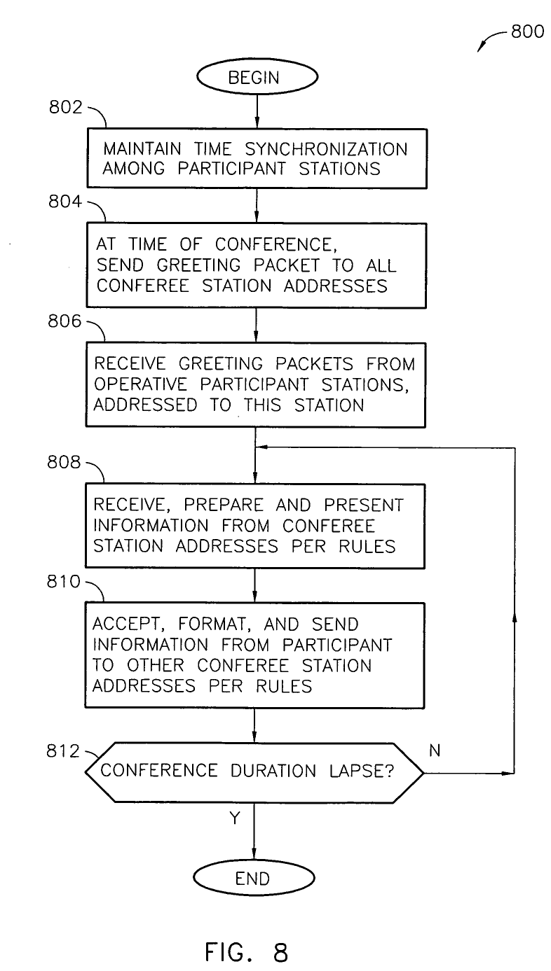

For example, method 800 of FIG. 8 may be performed by each conduct conference process 210. In the discussion that follows, the method is performed at a particular station referred to as the current station or “this” station. Each such process continually maintains (802) time synchronization with other stations that are scheduled to participate in an upcoming conference. In one embodiment, a sole authority of date-time information provides messages over network 101. In another embodiment, each station includes a calibrated source of date-time information for reference. In this manner, all stations that are to participate may prepare for or begin participation at a suitable time of the conference (e.g., suitable offsets prior to the conference start time).

When it is determined that action is to be taken by this station to prepare for or begin a conference (e.g., by comparing maintained current date-time to a suitable offset from conference start date-time), a greeting packet is sent to each conference station that has been scheduled to participate in the conference. In one embodiment, each controller 404 sends a conventional network “ping” message to other station addresses including its own address (e.g., a port of network interface 402) to assure that its own port is operational for the conference. Network addresses may be obtained from conference plans 208 or an address indicated by the needed at location discussed above.

Greeting packets are received (806) from other operative participants of the conference as a consequence of each such station sending (804) as discussed above. Each such greeting may be addressed to this station. In an alternate embodiment where network topology permits access to all packets (e.g., a ring), each station monitors the network and intercepts packets (e.g., accepts as received without interfering with reception by others) having an address of any station scheduled to be a participant.

After determining that scheduled participating stations are operative for conducting the conference by receiving greetings or acknowledgements of greetings sent, this station may conduct the conference for the participant at this station by receiving information (808) and sending information (810) for the duration of the conference (812) using the addresses verified to be operational as discussed above.

Receiving information may include receiving packets addressed from conference participant stations, preparing, and presenting information (e.g., audio, video, and data) to the participant at this station. Rules may dictate that some packets received from conference participants are to be obscured (e.g., in whole or in part muted, not shown, or scrambled) from the participant at this station. When audio is to be obscured, the speaker's image may also be obscured from the video portion of the conference.

Sending information may include accepting (e.g., via microphone, via camera, or by reading local data storage), formatting, and sending packets addressed to conference participant stations. Rules may dictate that some addresses are not to be used for some or all information (e.g., omitting, selecting, truncating, or scrambling).

Rules for conducting a conference may present the impression of private conferences as part of the main conference. For example, any two participants of a main conference may be joined (e.g., go off line as to the main conference) for a private one-on-one conference; and after a suitable time, return to the main conference. The one-on-one conference may be initiated by one of the two participants (e.g., using a participant station having suitable control input capability) or by a participant operating a control station. The video presentation for a one-on-one conference may be noticeably different from the video presentation for a main conference (e.g., different picture in picture quantities or locations or different border).

In an alternate implementation of method 800, use of a particular station by a particular participant is confirmed when the particular participant identifies himself or herself to any suitable participant station. For example, a prisoner or visitor may be directed to a group of stations and told to be seated at any idle station and then follow the instructions on the screen (e.g., for purposes of identification to a suitable conference). When a participant is seated at a station, a coordinator may (a) identify the participant in any conventional manner and (b) identify the station to a scheduled conference. For part (a), identification may be automated or manual. Automated identification may use voice print, thumb print, features of the participant's iris, photo comparison, or voice recognition (e.g., asking for and receiving the prisoners name or number) in a manner similar to rescheduling a conference to a known operative alternative as discussed above. For example, the coordinator may have a control station where control inputs for rescheduling may be made.

Screens are presented via a video monitor to inform participants, coordinators, and others about the current status and planned usage of a participant station. For example, a sequence of screens may guide entering a conference. Notices may inform the participant during a conference. Further, a sequence of screens may guide termination of a conference. Sequences and notices facilitate more efficient utilization of each participant station, especially increasing utilization of each participant station in a group of participant stations at a single site. Input from a control station (e.g., operated by a coordinator), current date-time, and input from a participant may trigger a transition from one screen to another in a sequence. Input from a participant may include a signal from a sensor that detects that a person is ready at a participant station. Such sensors may include a hook switch for a telephone type handset, a touch screen, a strain gauge in the seat detecting a person seated at a station, voice detection, or image detection. Screens for use in system 300 are described in Table 4.

TABLE 4

| Screen ID | Description | Sequence |
|---|---|---|
| Blank | A solid color screen or a conventional | After initialization, a hub instructs all its |
| | animated screen saver indicating that | peripheral stations to display the blank |
| | the station is operational and that there | screen. A general purpose station, |
| | is no scheduled use for this station in | control station, or participant station |
| | the near future (e.g., 3 minutes). | coupled to network 101 typically has at |
| | Animated screen saver may direct | least a basic set of processes as |
| | persons to identify themselves at a self | discussed above with reference to FIG. 2 |
| | service station (e.g., kiosk) or with a | for conference participation. After |
| | coordinator. | initialization of those processes, a blank |
| | | screen is displayed. Follows conference |
| | | audio/video screen when participant |
| | | initiate hang-up; or, follows hang-up |
| | | screen when conference is otherwise |
| | | terminated. |
| Reserved | A notice to the effect that the station is | Follows a blank screen. If the existing |
| | reserved for a conference. May | screen is not blank, some form of |
| | include identification of the participant | termination is generally completed, |
| | that is expected to use this station for | resulting in a blank screen. |
| | that conference. | Automatically triggered by current date- |
| | | time being about 2 minutes prior to a |
| | | start date-time of a conference |
| | | specifying use of this station. Manually |
| | | triggered as directed by coordinator |
| | | when a properly identified participant |
| | | shows up for a scheduled conference at |
| | | the site. Automatically triggered when |
| | | a participant operates a self service |
| | | station that confirms his or her identity |
| | | for a scheduled conference. |
| Pickup | Instruction for participant to pick up | Follows a reserved screen, though may |
| | the telephone handset (thereby | follow a blank screen when the reserved |
| | releasing the hook switch) and wait to | screen is omitted. Automatically |
| | be connected. Audio on handset | triggered by current date-time being |
| | speaker may be further instructions, | about ½ minute prior to a start date- |
| | advertising, or “hold” music. May be | time of a conference specifying use of |
| | two screens: pickup, and wait; thereby | this station. Manually triggered as |
| | acknowledging handset was picked | directed by coordinator when a properly |
| | up. | identified participant shows up for a |
| | | scheduled conference at the site. |
| | | Automatically triggered when a |
| | | participant operates a self service station |
| | | that confirms his or her identity for a |
| | | scheduled conference. |
| Conference | Generally a video image from one or | Follows pickup screen when at least this |
| audio/ | more cameras of the conference. May | participant and another participant has |
| video | have a unique border indicating that | the handset off-hook as indicated by the |
| | the conference is being recorded. | hook switch. Generally cannot be |
| | Border may be omitted if recording is | obtained when the current date-time is |
| | intended to be without notice to | outside the prescribed period of time of |
| | participant. May have a unique border | a properly scheduled conference - |
| | indicating that this is a subconference | conference start date-time and |
| | as opposed to the main conference | conference end date-time. Maintained |
| | (e.g., a temporary conversation by less | until conference is terminated: (a) by |
| | than the full conference participants). | this participant operating the hook |
| | May include fixed text or marquee text | switch; (b) by a coordinator that |
| | for notices (e.g., names of other | manually intervenes to terminate a |
| | participants attending/absent, names of | conference for any reason; (c) |
| | data participants, current date-time, | automatically as indicated when the |
| | elapsed time, time remaining, | current date-time exceeds the |
| | warnings that current date-time is | conference end date-time. |
| | within a threshold amount of the | |
| | conference end date-time). Visual | |
| | warnings may be replaced or | |
| | supplemented by audio warnings. | |
| Hang-up | Instruction for participant to put the | Follows conference audio/video screen. |
| | handset back onto the hook (thereby | Typically maintained for ½ minute. |
| | operating the hook switch) and either | |
| | (a) leave the station; or (b) standby for | |
| | another conference that this participant | |
| | is scheduled to attend. May use | |
| | separate screens for hang-up | |
| | instruction, instruction as in (a), and | |
| | instruction as in (b). | |

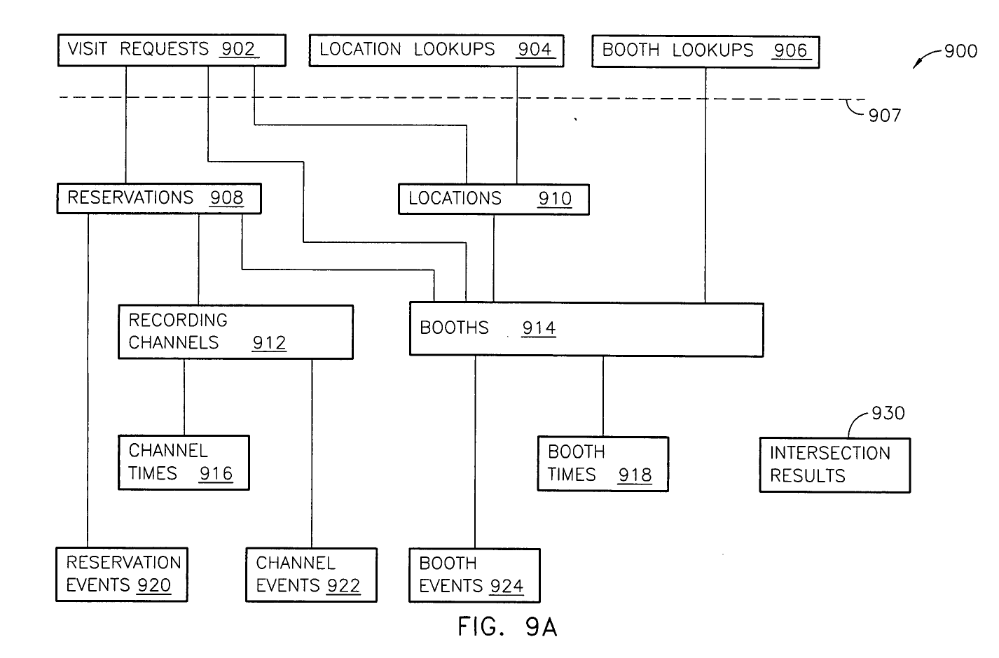

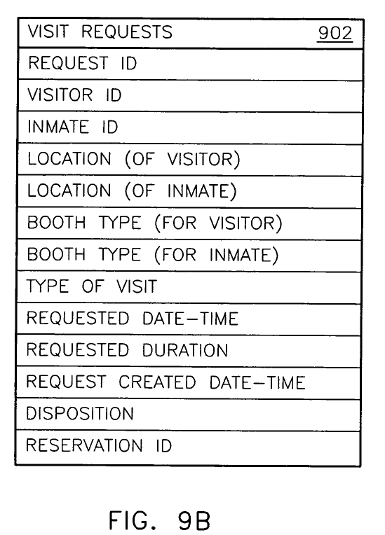

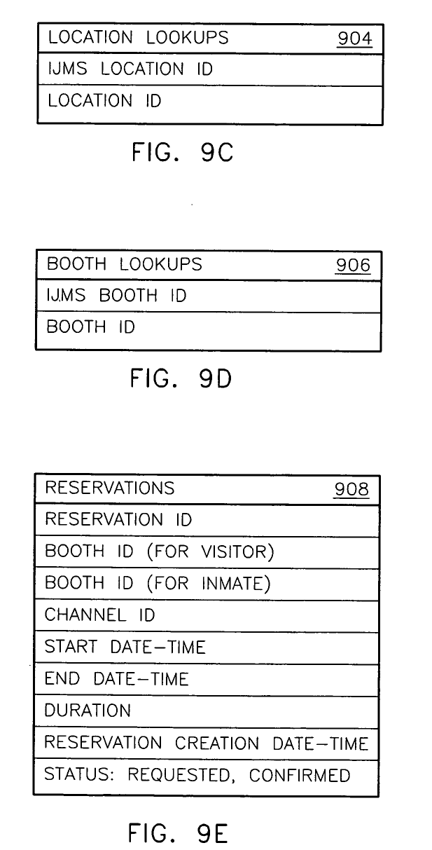

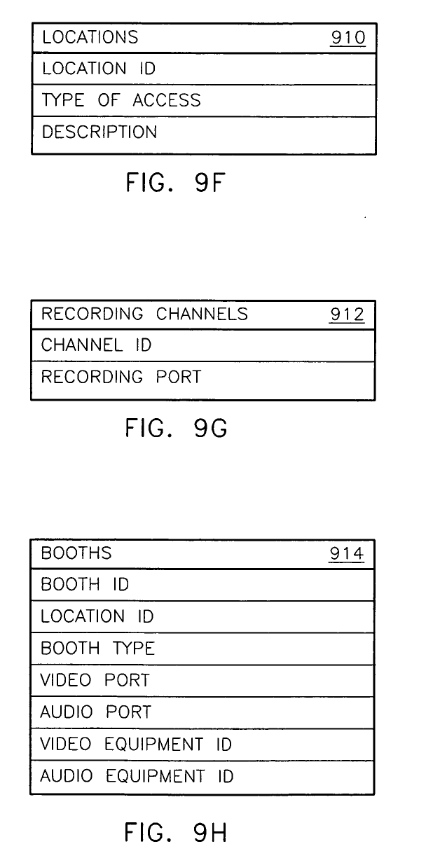

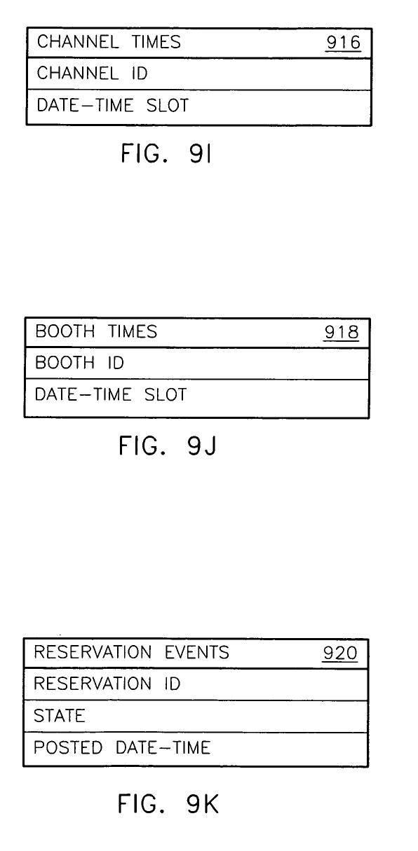

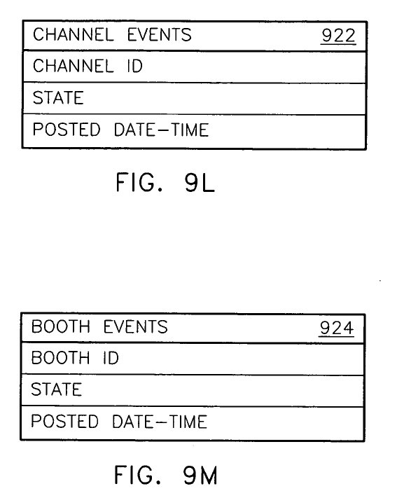

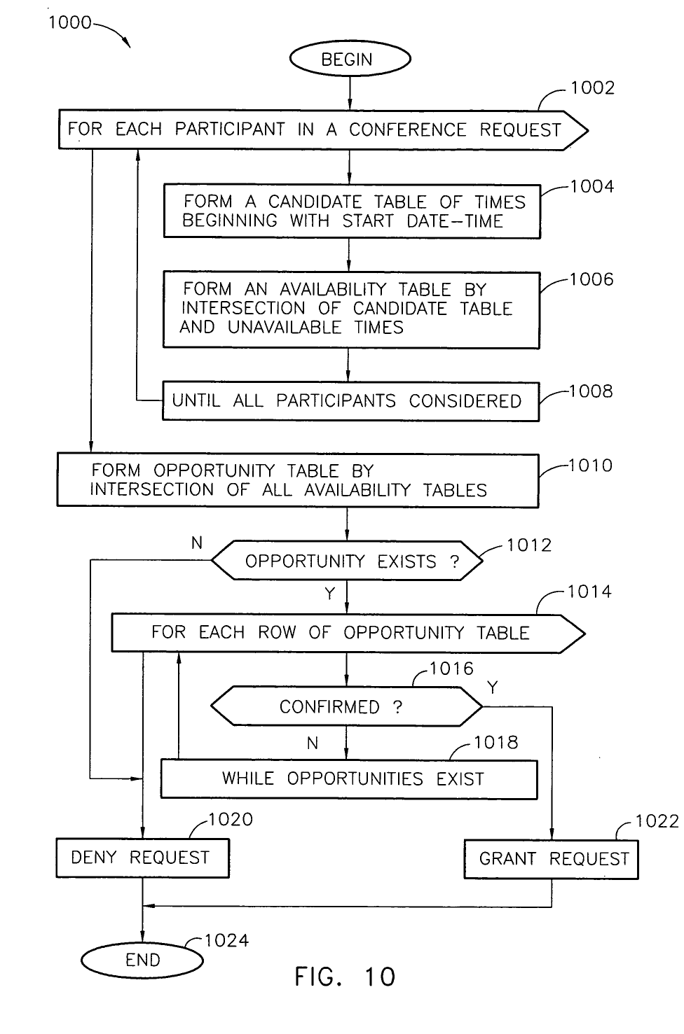

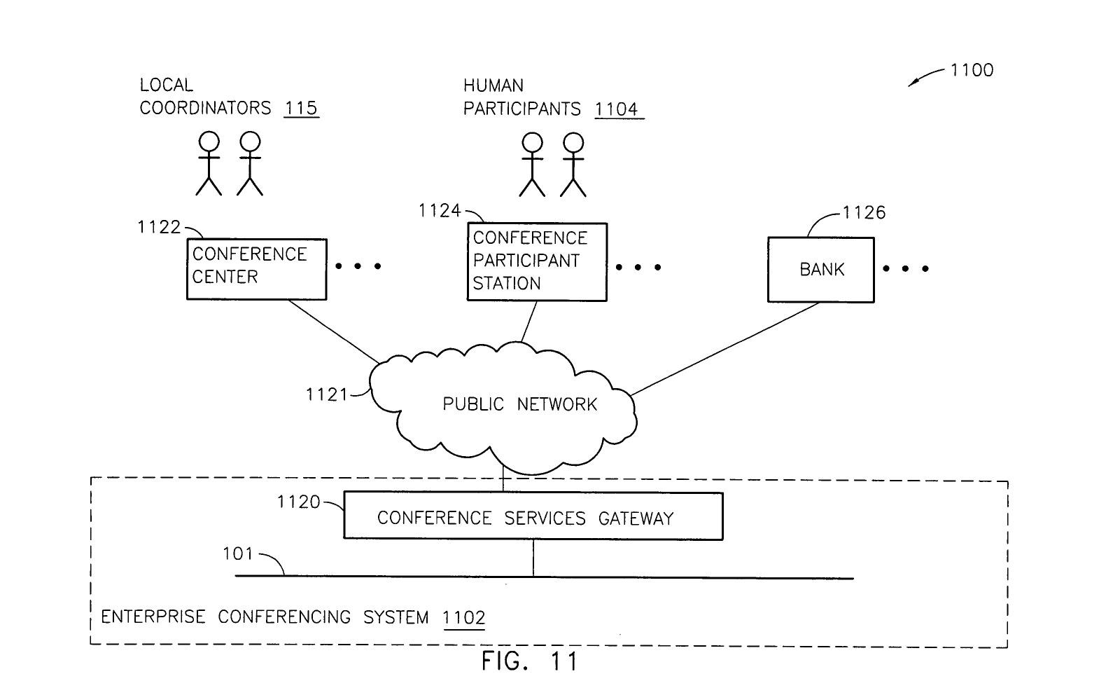

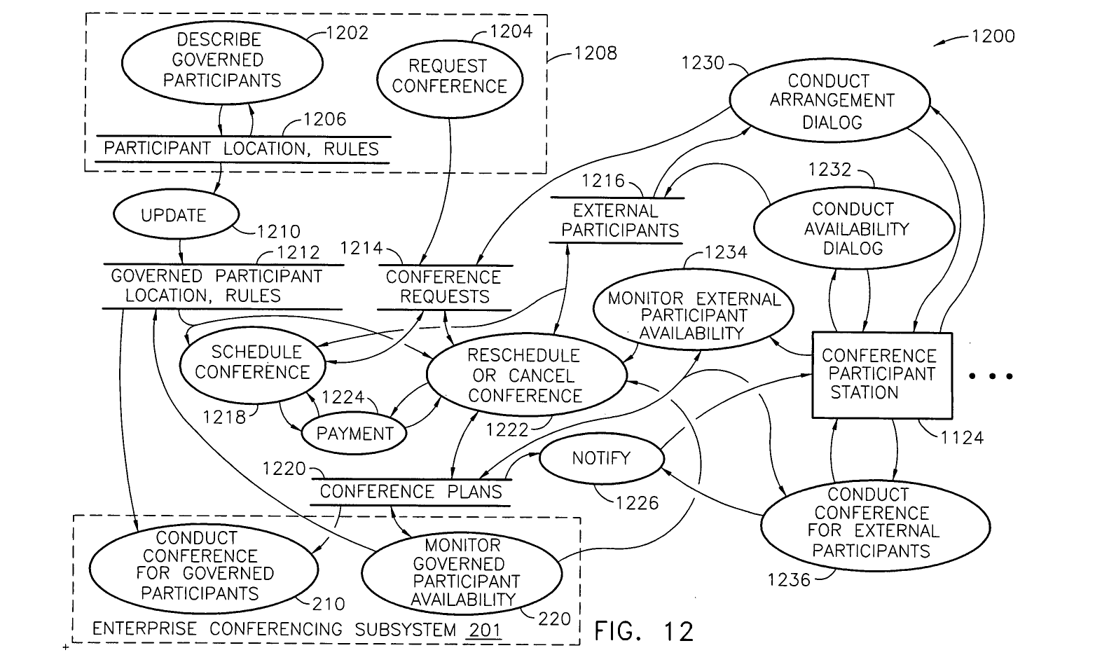

A database in another implementation according to various aspects of the present invention, uses set intersection to accomplish scheduling of a conference. For example, database 900 of FIG. 9A includes lists of records for visit requests 902, location lookups 904 and booth lookups 906. An interface 907 may limit access to other portions of database 900. For example, when visit requests 902, location lookups 904, and booth lookups 906, are stored on jail management system 304, control station 306, and/or office 311, operators and software running on those systems do not have access to other portions of database 900. Limiting access may be accomplished in any conventional manner (e.g., use of access control lists, user account privileges, a log-in protocol, a communication protocol, or restricting access to information which would enable access to other portions of database 900). Database 900 may be implemented in a central computer system where interface 907 is erected between processes or processors in any conventional manner. Such a computer system may include multiple cooperating servers. Database 900 further includes reservations 908, locations 910, recording channels 912, booths 914, channel times 916, booth times 918, reservation events 920, channel events 922, booth events 924, and intersection results 930. Fields of the records of each of each list are described in Table 5.

TABLE 5

| Field | Description |
|---|---|
| Request ID | A visit (e.g., a conference) is requested by providing the information |
| | stored in a visit request record 902. Information for a request may be |
| | supplied by a system or an operator, for example, manual input on a |
| | data entry screen. A visit request once made is given an identification. |
| | A visit request may result in a reservation being made or result in |
| | another disposition as described in the disposition field discussed |
| | below. |
| Visitor ID | A unique identifier for a person to be included in a conference. Where |
| | the person's given name is not unique, any additional information may |
| | be used in addition or in place of given name. The visitor may have |
| | been registered and issued an identification card or badge. By |
| | presenting the visitor card or badge to a conference coordinator, a match |
| | to the visitor ID may be made and the visitor may be positively |
| | identified for permission to make a visit request, or permission to |
| | participate in a scheduled conference. |
| Inmate ID | A unique identifier for an inmate, as discussed above. |
| Location | A visit request is made in terms of a location which may identify a site |
| | as discussed above, for example, a site having any number of |
| | conference participant stations. Although a reservation may uniquely |
| | specify particular conference participant stations, a visit request may be |
| | made in terms of particular conference participant stations or particular |
| | sites having one or more suitable conference participant stations. |
| Booth type | A conference participant station (herein called a booth) is a single user |
| | station that may be equipped for use by a handicapped person or a |
| | person with no handicap. Handicap may include limitations in physical |
| | mobility, seating, standing, and variations of conference equipment 218 |
| | to facilitate participation. In addition to handicap, any suitable |
| | distinction of booth type may be used to designate that a particular |
| | visitor or inmate prefers to use a booth of a particular configuration |
| | (e.g., booth type), as described above with reference to permitted type |
| | of visit. |
| Requested date- | The period of a conference may be requested as a start time and |
| time | duration or as a start time and an end time. |
| Requested duration | Duration may be specified in any suitable granularity (e.g., minutes, |
| | quarter hours, hours). The duration may also be specified as a code for |
| | a standardized duration (e.g., 27 minutes, 55 minutes). |
| Request created | A date and time corresponding to when the visit request record was |
| date-time | created. Requests that were created may be logged and archived. |
| | Access to visit requests may be indexed on any suitable field or |
| | combination of fields. Archiving may be based on the date and time the |
| | request record was created and its disposition. |
| Disposition | A request may be pending after first made, approved after manual |
| | review, granted after a reservation identification has been established |
| | for this visit request, on hold when the approved request has not yet |
| | been scheduled, or denied. The disposition field records a suitable code |
| | for these results and is available for queries. |
| Reservation ID | Each conference is identified in database 900 by a reservation identifier. |
| | The functions of a reservation identifier may be similar to the functions |
| | of a conference identifier as discussed above. |
| IJMS location ID | Interface to jail management system (IJMS) 907 may provide |
| | translation between location identifiers as used in the jail management |
| | system and location identifiers as used in a video conference system. |
| | The mapping of location codes known to the jail management system |
| | may provide access to all or a subset of location identifiers known to |
| | video conference systems. By omitting an entry in location look-ups |
| | 904 for a particular location identifier known to the video conference |
| | system, the jail management system may be unable to schedule a |
| | conference using that particular video conference location. Further, |
| | information about use of the video conference locations may be |
| | concealed from operators and processes of the jail management system. |
| | In an alternate implementation, reservations may be made by one or |
| | more jail management systems and/or one or more users of conference |
| | control stations of any type described above. For example, video |
| | conferences may be scheduled to include inmates via the jail |
| | management system. Video conferences may be scheduled for business |
| | purposes among any operators of conference stations 319 in office 311. |
| | A portion of reservations 908 and related lists of records, may be |
| | maintained in a distributed manner. For example, reservations related |
| | to locations known to the jail management system may be stored with or |
| | as a part of database 304. Records for visits may be stored at any |
| | station or hub. |
| IJMS booth ID | The booth identifier known to the jail management system may differ |
| | from the booth identifier known to the video conference system. The |
| | difference between a jail management system booth identifier and a |
| | video conference system booth identifier is analogous to the difference |
| | discussed above with reference to a jail management system location |
| | identifier. A booth identifier specifies the location of a particular single |
| | user conference participant station. |
| Channel identifier | For conferences to be recorded, Channel identifier identifies the facility |
| | to be used for recording the conference. The recording facility may |
| | include audio and video recording at one or more hubs as discussed |
| | above. |
| Status: Requested, | In a minimal system the status of a reservation may be designated as |
| confirmed | requested (for a visit request that is on hold) or confirmed (when a visit |
| | request has been scheduled). Confirmation of a reservation may require |
| | operator input at any conference station. |
| Type of access | Access to a location may be subject to personal security limitations. |
| | Access type may be described to a Boolean designating whether the |
| | area is accessible to visitors or not. An area confined for inmates is |
| | generally not accessible to visitors. A booth located in a visitor center |
| | 312 would generally be identified as accessible to visitors. |
| Location | A street address or physical description of the location. May be |
| description | presented during manual confirmation of a conference. |
| Recording port | Several recording ports may be identified to the same channel identifier |
| | for the purpose of separately recording audio and video signals. |
| | Additional ports may be identified through the same channel identifier |
| | to support recording from several participant stations. Any channel |
| | may include recording of a formatted composite video signal (e.g., |
| | audio and video formatted from several stations). |
| Video Port | An identifier of the video signal source (camera) of the identified booth. |
| | A port may be a network address or multiplex circuit selection code. |
| Audio Port | An identifier of the audio signal source (handset) of the identified |
| | booth. A port may be a network address or multiplex circuit selection |
| | code. |
| Video Equipment | A serial number of the video equipment for tracking video equipment |
| Identifier | reliability. |
| Audio Equipment | A serial number of the audio equipment for tracking audio equipment |
| Identifier | reliability. |
| State | For equipment, state describes (e.g., by a suitable code) status and |
| | configuration of equipment. State may include on/off line flag, date- |
| | time back in service, date-time last tested, or other equipment reliability |
| | tracking information. State may also include whether or not the |
| | equipment is functional. A transition from functional to non-functional |
| | may give rise to rescheduling the conference as discussed above. For a |
| | reservation, state may include a record of the presentation of screens as |
| | described above with reference to Table 4. For a channel event, state |
| | may include beginning and ending recording as controlled, for example, |
| | by a designated hook switch or operator control at a monitoring |
| | conference control station. For a booth, state may include the status and |
| | progress of the conduct of a video conference (e.g., posting date-time of |
| | hook switch changes, posting date-time of screen presentations as |
| | discussed above with reference to Table 4). |
| Posted Date-Time | The date and time at which the event record was created, or the date and |
| | time that a change of state was recognized. |
| Date-Time Slot | Time slots on particular dates are filled when a video conference is |
| | scheduled that commits that time slot. A slot is a period of time in any |
| | suitable granularity. One or more time slots may be used to satisfy the |
| | requested duration of a visit request (902). |

Database 900 accommodates visits having one visitor and one inmate. An alternate implementation of database 900 accommodates visits having a larger maximum number of participants. In the alternate database, a visit request record 902 includes a tuple of values for ID, LOCATION, and BOOTH TYPE for each of several visitors (e.g., four) and for each of several inmates (e.g., two). Further, a reservation record 908 includes a corresponding number of values for BOOTH ID to accommodate all participants.

A method for recording a video conference, according to various aspects of the present invention, may include recording audio and video originating at each of several conference participant stations and recording the date and time of events associated with the video conference. An event includes any change of state or any change of the contents of a database record (e.g., create, modify, delete). By recording events in the form of new or revised database records, access to a particular video conference or access to a portion of a video conference is facilitated according to any conventional database access technique (e.g., selection of particular events, selection of video conferences that include a particular event or sequence of events, selection of a video conference having particular participants, selection of video conferences that occurred at a particular location or for a particular period of time).

A video conference may be requested and scheduled according to a method that uses set intersections to efficiently accomplish scheduling. In such a method, temporary database lists (e.g., files, indexes, or views) may be created in advance of scheduling a particular request or a set of requests. For example, channel times 916 and booth times 918 may be created in advance of scheduling requests in general and maintained for reference when scheduling requests. Intersection results 930 may be prepared in response to a request and discarded when the request has been either granted or denied. For example, method 1000 begins with a loop for considering each participant in a conference request (1002). For each participant, a candidate table is formed (1004). A candidate table includes a list of time slots beginning with the start date and time of the requested conference. A candidate table may extend for any suitable period likely to include a successful conference reservation start date and time. For example, a candidate table may extend for 24 business hours (or 24 time slots) ahead of the beginning start date and time. Each time record of a candidate table may correspond to a time slot as discussed above. Next, an availability table is formed. The candidate table and availability table are part of intersection results 930. An availability table is formed (1006) as a result of the intersection of the candidate table and a list of times that are unavailable. A list of unavailable times may be prepared for a particular location and period of time by a suitable query of reservations 908. A list of booth identifiers suitable for such a query may include all identifiers identified to the requested locations for the visitor and inmate (and any other participants in the conference). A candidate table and an availability table are formed for each participant (1008) until all participants have been considered. For the purpose of this loop, a participant includes any person, station, recording facility, equipment, or data that may be required for conduct of the requested video conference.

After participant availability tables have been formed, an opportunity table is formed (1010) as a result of the intersection of all availability tables discussed above. An opportunity table may have zero or more records resulting from the intersection of availability tables. If the opportunity table has no records, the conference request may be denied (1020). On the other hand, if it is determined (1012) that one or more opportunities exist (e.g., that more than one record has been listed in the opportunity table), then each row of the opportunity table is considered for scheduling (1014).

For each row of the opportunity table, it is determined whether the time associated with that opportunity is suitable for a video conference. Suitability may be confirmed by any process or operator of a conference station. For example, in a prisoner visitation system, it may be prudent to require confirmation of a video conference by a guard using a conference control station who may be knowledgeable of situations within the prison that may endanger the conference participant (e.g., the named inmate should not be located for the purpose of a conference in an area of the prison dominated by his enemies). A self help kiosk may supply confirmation input entered by a visitor. After it is determined that the opportunity is confirmed, the visit request may be granted (1022) and a record in the reservation list 908 may be identified as confirmed. Intersection results 930 (e.g., including the candidate table, availability table, and opportunity table) may be discarded. On the other hand, if confirmation (1016) is not obtained, then other opportunities in the opportunity table may be considered (1018), while opportunities in the opportunity table have yet to be considered.

After all opportunities in the opportunity table have been considered and no opportunity has been confirmed (1016), the visit request may be denied (1020). After granting (1022) or denying (1020) of a visit request, the method is complete (1024) wherein the disposition of the visit request 902 may be established in any suitable manner.

Particular advantages are obtained according to various aspects of the present invention so as to facilitate rapid scheduling of video conferences. For example, by maintaining channel times 916 and booth times 918 with records for a suitable number of future time slots, calculation of available date-time slots for a channel or a booth may be simplified in scheduling each visit request. In other words, by maintaining a list of date-time slots associated with a potential conference participant, and querying that list to form a candidate table (1004) as discussed above, the determination of unavailable time is greatly simplified. Further, when a participant's availability changes, for example, when a visitor center changes visiting hours, affecting the availability of all booths at that visiting center, such a change may readily be recorded as a change in booth times 918. As another example, when a booth is expected to have periodic maintenance or when unexpected failure of the booth will require an extended period of time for repair, changes in booth times 918 may be made so that reservations are not granted for periods of time when the booth is not available.

In another implementation, equipment times 728, inmate times 730, and visitor times 732 are recorded in lists in a format similar to booth times 918 for use analogous to booth times 918 discussed above.

In an implementation having multiple hubs, each with a portion of the scheduling data relevant to their conference participant stations, scheduling a conference may include requesting at a first hub an availability table or an opportunity table from a second node. In addition to the channel times, booth times, other equipment times, inmate times, and visitor times discussed above, each hub maintains network port times (not shown) as a list in a manner analogous to booth times 918 for scheduling a limited number of network ports of network interface 402. A request for a table may include a list of the participants scheduled by the second hub. Participants may include conference participant stations, one or more network ports, a recorder channel, auxiliary equipment, and auxiliary data items. The request may further include a specification of the requested conference start date-time, an extent of the candidates table (e.g., to assure uniformity in availability tables), identification of the type of table requested by the first hub (e.g., availability table for each requested participant, opportunity table for the combination of requested participant, or a combination of tables), and a hold time sufficient for the first hub to complete the scheduling process. The hub receiving a request may prepare the requested table or tables and deliver these results to the first hub. If a hold time is omitted by the first hub, the second hub may specify a hold time after lapse of which the provided data is no longer valid for scheduling purposes. The second hub may make a suitable record in its database and hold all time slots delivered for the hold time. After the first hub accomplishes preparation of availability tables, preparation of an opportunity table, selection of an opportunity, and confirmation to schedule the conference in accordance with the selected opportunity, the first hub may inform the second hub of the conference schedule (e.g., conference identifier, start date-time, end date-time, and rules for conducting the conference). The second hub may schedule the conference as to the participants (e.g., stations, equipment, network nodes, recorder channels, data items) under its control and provide an acknowledgement of success to the first hub.

The method discussed above may be extended to operate from the first hub to any number of second hubs. The request may further include a list of hubs that are included in scheduling the conference. When the first hub receives notice of successful subordinate scheduling by one or more second hubs, the first hub may consider the request for a conference successfully completed.

If a hub detects that a participant for the conference is or likely will be unavailable at the start date-time for the conference, the hub may reschedule the participant with cooperation with other hubs if needed. Cooperation may be needed, for example, when conduct of the conference by a hub makes reference to a participant (e.g., a network node) of a second hub. If a hub has an alternate conference participant station for a conference participant station that was scheduled but is likely not available for the conference, the hub may reschedule a suitable portion of the conference schedule to use the alternate conference participant station without providing notice of rescheduling informing other hubs that may be involved in the conference. If the hub determines that the conference must be cancelled due to unavailability of some or all of the participants it schedules, the hub may provide notice of cancellation to one or more hubs indicated in the request as being involved in the conference. A second hub may reschedule all or its portion of the conference in response to receiving notice of rescheduling or cancellation to free resources for other conferences.

Databases 700 and 900 and methods discussed above may grant conference reservations on a first-come first-served basis. In an alternate implementation, each request and reservation is associated with a respective rank. Reservations having lower rank than a pending request are subject to rescheduling to accommodate the higher ranking request. For example, an alternate conference record 702 further includes CONFERENCE RANK reflecting the highest participant rank or a conference rank specified in a conference request. An alternate visit request record 902 and alternate reservation record 908 each includes a CONFERENCE RANK. Conference rank may be an integer having higher values for higher priority scheduling and higher immunity to being rescheduled by subsequent requests. An alternate method 1000 includes the preparation of a list of unavailable times for a participant that includes scheduled times of lower ranking conferences. In other words, the fact that a participant is included in a lower ranking conference at a particular time does not eliminate that time from consideration for a higher ranking scheduling (or rescheduling) process. After a higher ranking conference request is granted, schedule conflicts may have been created for one or more participants. Elimination of these schedule conflicts may be accomplished by converting each conflicted conference into a request, placing the requests in sequence in a queue, and rescheduling each request possibly adding further requests to the queue until the queue is empty. Sequence may be determined with reference to conference rank, date and time of the original request, number of times previously rescheduled, transit time allowances for participants, and allowances needed for notifying participants of rescheduling. Fields for maintaining such information may be added to suitable records of database 700 or 900.

An alternate implementation of databases 700 and 900 may accommodate sufficient time for notifying participants in the event of a scheduling, cancellation, or rescheduling action. If sufficient time is not available for notifying a participant, the scheduling request may be denied, the request to cancel (e.g., for a higher ranking conference) may be denied, or the request to reschedule may be denied. Consequently, another time slot may be considered for the requested conference; or another request may be generated manually or automatically with a greater allowance for notification in an effort to successfully meet all notification criteria.

An alternate conference record 702 may include a rule or value that determines a minimum allowed notification time (e.g., sufficient to meet the maximum of notification times associated with participants). A value of this type may be included in each of an alternate equipment description record 716, an alternate inmate record 712, and an alternate visitor record 714. A value of this type may be included in each of an alternate conference request record 902, an alternate reservation record 908, and an alternate booths record 914.

Because the satisfaction of a relatively high ranking conference request may initiate an unacceptable system rescheduling burden and/or an unacceptable profusion of notices to coordinators and participants, an alternative schedule conference process 204 or 1000 may score the rescheduling and notification burden and report the score for acknowledgement by the administrator or requester prior to initiating scheduling and consequent rescheduling. Such a score may be accomplished by performing the scheduling processes as discussed above in a temporary workspace until the queue of rescheduling requests has been emptied. The estimate may be based on one or more (e.g., a sum or weighted sum) of a count of the total number of rescheduled conferences, a count of the total number of coordinators and/or participants to be notified, and transit times (e.g., those exceeding a threshold) for participants effected by rescheduling.

As discussed above, network 101 of system 100 may include private network and public network portions in any conventional manner. For example, network 101 may include an enterprise network. An enterprise is generally an organization and all its hierarchical subordinate organizations that may be diverse in geographic location, network protocols, and computing hardware and software, as for example a corporation with subsidiaries or a government agency with offices in various jurisdictions. An enterprise network generally comprises a network having links to all portions (e.g., nodes) of an enterprise and may have public network and private network portions. Security of the enterprise network may be provided by conventional encryption, firewall, user registration, and user identification technologies applied to nodes (e.g., servers and stations) coupled to the enterprise network.

System 100 provides controls on access to data and operations by users to assure the security of data and processes of system 100. For example, conferences participants using system 100 generally make a request for a conference to an administrator who is permitted to initiate a scheduling function of system 100. The administrator, as a trusted member of an enterprise, is able to enforce policies of the enterprise as to whether a particular request for a conference is denied or scheduled. Network 101 of system 100 may be secured as an enterprise network in a manner so that all conference participation occurs at conference participant stations that are linked to network 101. Consequently, conference participants may have access to data and processes of the system only through a sequence of screens during the time of a scheduled conference (e.g., Table 4). As discussed above, this access may be extremely limited.

In other systems according to various aspects of the present invention, an enterprise network serves: (a) one or more conference participant stations coupled to the enterprise network on the enterprise side of a gateway (internal stations); and (b) one or more conference participant stations coupled to the enterprise network through the gateway (external stations). Generally, though not necessarily, internal stations are used by governed participants and external stations are used by external participants.

A participant who is part of the social, economic, or political enterprise (e.g., by membership, employment, jurisdiction) is considered governed by the policies of the enterprise and so is referred to as a governed participant. Governed participants may also include those having a relationship to the enterprise that is recognized by the enterprise, for example, by a rule as discussed above. For instance, as to a conferencing system deployed for prison visitation, the enterprise may include government employees of a prison and prisoners; and additional governed participants may include judges and attorneys who are trusted to abide by enterprise policies. Otherwise, as to a conferencing system deployed for commercial collaboration, the enterprise may include employees of a manufacturer with a need to know particular to a product or research effort.

A participant who is not part of the enterprise (e.g., a visitor, nonmember, non-employee, employee without need to know, or person outside the jurisdiction) is referred to as an external participant. For instance, as to a conferencing system deployed for prison visitation, external participants may include friends and relatives who wish to initiate a conference with a prisoner. Otherwise, as to a conferencing system deployed for commercial collaboration, external participants may include stock holders, consultants, vendors, and customers.

Governed participants may include equipment subject to the control of the enterprise. External participants may include equipment not under the control of the enterprise.

According to various aspects of the present invention, cooperation of an enterprise conferencing system and a gateway permits, among other functions, an external station to be operated (e.g., by an external participant) to accomplish one or more of the following: (a) conducting a dialog for arranging or changing a request for a conference, (b) conducting a dialog regarding participant availability, (c) initiating a scheduling function of the system, (d) monitoring availability of the participant, and (e) conducting a conference for a participant. These functions are provided with barriers to access so that policies of the enterprise may be enforced with or without a human element (e.g., an administrator). In such a system, barriers to access, according to various aspects of the present invention, may include one or more barriers between the external participant and those processes and data to which the enterprise's security policies apply.

For example, system 1100 of FIG. 11 includes enterprise conferencing system 1102 having conference services gateway 1120. Enterprise conferencing system 1102 is typical of one or more such systems that may cooperate for a conference. A gateway couples an enterprise conferencing system to external stations via a public network. In system 1100, public network 1121 provides access to gateway 1120 from any number of conference centers 1122, any number of conference participant stations 1124, any number of banks 1126, and any number of other enterprise conferencing systems 1102. The term any number when zero describes omission of the item. Gateway 1120 has access to enterprise network 101 on an enterprise side of gateway 1120 and has access to public network 1121 on an external side of gateway 1120. Such access permits external stations and internal stations (of each enterprise) to be suitably included in a video conference.

Enterprise conferencing system 1102 may include an implementation of system 100 (in any configuration discussed above with reference to FIG. 1) coupled to the enterprise side of conference services gateway 1120. Gateway 1120 is coupled between public network 1121 and enterprise network 101 with links of any conventional configuration and bandwidth suitable for numerous concurrent conferences. Coupling for audio and video communication is accomplished by public network 1121 and enterprise network 101. Gateway 1120 may perform audio and video data protocol conversion, for example, between packet based protocols (e.g., TCP/IP, ATM) on network 1121 and analog combined audio and video (e.g., NTSC, PAL).

System 100 may require identification of a user (e.g., supervisor, administrator, coordinator, or governed participant) for registration and/or prior to conducting a session with that user for operations permitted to that user. System 1100 may require identification (of a type as in system 100) of a user (e.g., supervisor, administrator, coordinator, governed participant, or external conference participant) for registration and/or prior to conducting a session with that user for operations permitted to that user. Conventional user registration processes and user login processes may be used. An authorized user may perform operations for an unauthorized user. For example, an administrator may make a reservation at the request of a governed participant. Each user of system 1100 may be registered to one or more roles as discussed, for example, in Table 6.

TABLE 6

| Role | Description |
|---|---|
| Supervisor 113 | Generally, a person who is part of the enterprise and entrusted to a |
| | superior degree with access to information and permission to invoke |
| | functions of system 100 without limitation. Supervisors enter and |
| | maintain descriptions of governed participants including, for example, |
| | the location of governed participants and whom they may conference |
| | with. System 1100 includes barriers to access enterprise data and |
| | processes via network 1121 (e.g., supervisory functions and data such |
| | as location of governed participants). Generally, system 1100 does not |
| | permit supervisors to use conference center 1122 or conference |
| | participant stations 1124. |
| Administrator 114 | Generally, a person who is part of the enterprise and entrusted to a |
| | lesser degree than a supervisor yet having access to information and |
| | permission to invoke functions of system 100 with some limitations. |
| | For example, an administrator may validate a request for a conference |
| | with comparison to whom a conference may include; and initiate |
| | scheduling of a conference. Generally, system 1100 does not permit |
| | administrators to use conference center 1122 or conference participant |
| | stations 1124. |
| Coordinator 115 | Generally, a person who is part of the enterprise yet not trusted with |
| | information beyond what is needed to facilitate a scheduled conference. |
| | Coordinators relocate and configure equipment participants and notify |
| | human participants. A coordinator assists participants (e.g., as an escort |
| | or receptionist) in getting to particular locations for scheduled |
| | conferences. Coordinators may have access to schedules to answer |
| | inquiries about scheduled conferences (e.g., When is my next visit with |
| | prisoner Smith?). System 1100 permits notices to coordinators via |
| | network 1121. |
| Governed | Generally, a person who is permitted to ask that a conference be scheduled |
| Participant 116 | by an administrator and to participate in a conference only if named as a |
| | participant. A governed participant may be limited to use only conference |
| | participant stations of enterprise conferencing system 1102. |
| External Participant | Generally, a person having a privilege to operate a conventional computer |
| 1104 | as a conference participant station 1124 or use conference center 1122 of |
| | system 1100 (e.g., by virtue of registration and login). System 1100 |
| | allows external participants to use any conference participant station 1122, |
| | 1124, or one of system 100 (e.g., visiting center 312). |

Use of system 1100 may be billed to its users. For example, payment may be required to be validly made in conjunction with a request, an arrangement for a conference (or change of arrangements), and/or participation in a conference. Any conventional technologies may be used to initiate, validate, and accomplish payment by human users 1104 via conference center 1122, conference participant station 1124, and bank 1126. Identification for purposes of payment (e.g., reading a credit card and/or biometric card) may be used as identification sufficient for registration and/or login.

Conference center 1122 may include quantity of any conference participant stations (e.g., 104, 105, 106) at a particular location (e.g., analogous to visiting center 312). For example, conference center 1122 may be implemented with personal computer based video conference equipment (e.g., TCP/IP based) and/or with closed circuit television equipment (e.g., NTSC, PAL based) with one or more hubs (e.g., 322) having protocol conversion (e.g., analog based to/from packet based). Centers 1122 may be located in public access buildings (e.g., a library, courthouse, shopping center). Rent for use of such facilities may be paid from charges to participants. System 1100 may permit use without local coordinators 115: (a) where participant stations require log in; and/or (b) where notice as to which station to use is provided (in advance or on screen) to external participants 1104.

An enterprise conferencing system according to various aspects of the present invention provides reliable video conferencing involving internal conference participant stations and external conference participant stations. For example, enterprise conferencing system 1102 may include an implementation of conferencing system architecture 1200. Architecture 1200 includes proprietary data and processes 1208, update process 1210, governed participants store 1212, conference requests store 1214, external participants store 1216, schedule conference process 1218, conference plans 1220, reschedule or cancel conference process 1222, payment process 1224, notify process 1226, any number of enterprise conferencing subsystems 201 for use by governed participants, any number of conference participant stations 1124 for use by external participants, conduct arrangement dialog process 1230, conduct availability dialog process 1232, monitor external participant availability process 1234, and conduct conference for external participants process 1236.

In an enterprise where conferencing is a function added to an existing enterprise architecture, there may be reason to erect barriers to access between the conferencing functions and proprietary data and processes of the enterprise. For example, proprietary data and processes 1208 includes describe governed participants process 1202, participant location and rules store 1206, and request conference process 1204. Process 1202 performs as described above with reference to process 202 of FIG. 2. Generally, only supervisors may access process 1202. Process 1204 generates a conference request for scheduling as discussed above with reference to process 204. Generally, administrators access process 1204. Participant location and rules store 1206 may have structures and functions as discussed above with reference to participant location and rules store 206 (e.g., 304, Table 1). In system architecture 1200, participant location and rules store 1206 may serve as a sole authority for information stored there.

Update process 1210, from time to time receives from participant location and rules store 1206 data to update governed participants store 1212 and may also update external participants store 1216 (e.g., permissible registrants). Update process 1210 may operate without interaction with a user interface. Consequently, update process 1210, when proven to operate correctly, provides a reliable barrier to access to participant location and rules store 1206. Even if store 1212 (1216) was altered in an unauthorized or catastrophic manner, the sole authority for participant location and rules, store 1206, would not be affected and store 1212 (1216) may be restored within a suitable update period.

Data received from proprietary data and processes 1208 may be unsolicited as to the remaining processes of system architecture 1200. In one implementation, data is received according to one or more subscriptions (e.g., without repeatedly requesting data) with reception occurring automatically at a period of about 5 minutes. The subscription may be initially granted according to a request sent by a configuration process (not shown) of architecture 1200.

Stores 1206, 1212, and 1216 may be implemented with relational database technology. Store 1212 (1216) may be updated from a query or report (e.g., a subscription to certain data) to reflect a subset of the information stored in store 1206. Such a query or report functions as another barrier to access by including only a subset of the data from store 1206 in store 1212 (1216). Stores 1206, 1212, and 1216 may include rules that limit scheduling of conferences as discussed herein. Rules may be received in general (e.g., by update process 1210) and stored in particular to one or more conferences (e.g., as in records 702 implemented in store 1210).

Processes 1218 and 1222 generally make frequent reference to stores 1212, 1214, and 1216. By maintaining an update of store 1206 in store 1212, processing throughput (e.g., latency, responsiveness, availability) of proprietary data 1206 is unaffected by processes 1218 and 1222.

An interface between proprietary data and processes 1208 and other parts of system architecture 1200 may allow only read-only access to proprietary data and no access to proprietary processes. Store 1206, as shown, illustrates a more secure store than store 206 against some types of failures. As shown, only process 1202 has write access to store 1206. In contrast, store 206 allows write access from monitor participant availability process 220. In another implementation, limited write access is also permitted, as discussed below.

Several proprietary systems may be served in a conference system architecture 1200. For example, proprietary data and processes 1208 in one instance may correspond to jails in a first jurisdiction (e.g., state and local) and in another independent instance may correspond to jails in a second jurisdiction (e.g., federal). Stores 1212, 1214, 1216, 1220 may be managed to prevent or permit conferences among participants of different enterprises. Data for each enterprise may be separated (logically and/or physically) data of other enterprises. For example, an attorney at one conference station 1124 may request and participate in an uninterrupted series of back-to-back visits with prisoners, judges, and other attorneys, each participant from an independent enterprise.

Request process 1204 posts each request for a conference in conference requests store 1214. Posted requests may have been validated by an administrator in any conventional manner. For example, rules (1206) that may apply to each participant named in the request may be referred to by the administrator to determine whether the request is valid.

An external participants store includes information describing registered external participants such as identification, availability, and addresses for communication (e.g., public network address (IP address), email address, pager number, cellular phone number). For example, external participants store 1216, includes for each registered participant: name, mailing address, phone number, social security number, email address, cellular phone number, pager number, data for an identification dialog, the availability of the external participant as a list of dates and times, and information for payments from and refunds (or credits) to the participant. Store 1216 may include information as to location and rules describing the external participant.

Stores 1212, 1214, 1216, and 1220 may include structures and functions as discussed above with reference to databases 700 and 900. In one implementation, store 1212 includes data as in records 712, 720, 722, 724, 726, 730, 904, and 906. Store 1216 includes data as in records 714, 726, and 732. Store 1214 includes data as in records 902. And, store 1220 includes records as in the remaining lists of databases 700 and 900.

Schedule conference process 1218, for each conference request 1214, analyzes governed participants data 1212 for each governed participant named or implied by the request, analyzes external participant data 1216 for each external participant named or implied by the request, analyzes existing conference plans 1220 for prior commitments, verifies suitable payment is authorized or made, and posts a conference plan 1220. Generally, scheduling operations of process 1218 are analogous to those of process 204. Process 1218 may write status of a request to conference requests 1214. When governed participants store 1212 (or requests 1214) includes location and booth cross reference information as discussed above with reference to lookups 904 and 906, schedule conference process 1218 may implement the scheduling methods discussed above with reference to databases 700 and 900.

Conference plans 1220 may include structures as in databases 700 and 900 and may facilitate the functions of system architecture 200 as discussed above. Stores 1212, 1214, 1216, and 1220 may be implemented as a database having conventional database management capabilities.

Reschedule or cancel conference process 1222 operates in a manner analogous to process 222. In addition to responding to monitor participant availability process 220, process 1222 also responds in an analogous manner to input from monitor external participant availability process 1234. Notifications, cancellation, and/or automatic rescheduling may result from participant unavailability during a period of time just prior to conference start time, or during the scheduled conference time. Availability may be monitored for human participants and/or equipment participants. The duration of the period of time prior to conference start time may be determined with reference to the minimum time for suitable notification and the maximum transit time as discussed above.

A payment process obtains authorizations, obtains payments, and requests refunds (or credits) via conventional communication with a bank or clearinghouse. The link to the bank or clearinghouse may be a private network link (not shown) or a link via a public network 1121. For example, payment process 1224 may, for each suitable participant, communicate with one or more banks 1126 and perform suitable operations to verify payment is authorized and/or validly made at suitable times prior to the delivery of services (e.g., scheduling and/or conducting a conference). Suitable participants may be identified according to rules from store 1212. For example, a charge for making a request may be made payable only by the requester; a charge to reschedule may be made payable only by a participant not available at the scheduled conference time; and a charge proportional to the duration of the conference and charges for the use of equipment during the conference may be made payable in any manner by one, some, or all conference participants. Payment by a governed participant may be arranged by an administrator. Payment (or refund) may be made to one or more accounts (e.g., of the enterprise and/or the conferencing system administrator). In one implementation, system 1200 keeps accounts of a nonnegotiable tender (e.g., scrip) so that use of the conferencing system may be enabled without financial payment, for example, as a reward to governed conference participants.

Credit card authorization may be obtained at the time a request is scheduled. Payments may be committed when the conference begins, for example, to penalize failure to attend a conference. Payments (e.g., based on duration of the conference) may be committed when the conference ends.

Process 1226 notifies external conference participants of the establishment, revision, cancellation, and status of conference plans by e-mail, automated telephone system and/or text paging. Notify process 1226 may provide the screen sequence discussed above with reference to Table 4 in cooperation with any conventional input controls (e.g., dialog box(es) or button(s)). Notify process 1226 may provide notices that include driving directions (e.g., to a conference center 1122 nearest the current location of the external participant).

The interaction between an enterprise conferencing subsystem 201 in system architecture 1200 may be implemented primarily with conduct conference for governed participant process 210 and monitor governed participant availability process 220. These processes are as discussed above. Because these processes do not interact with proprietary data and processes 1208, communication may be implemented fully or in part via a public network. Suitable security against wiretapping may be added. One or more enterprise conferencing subsystems 201 may be included in conference center 1122.

A conference participant station 1124 may differ significantly from conference participant stations 106. A conference participant station 1124 suitably includes a user interface for requesting a conference. This interface may include any conventional interface such as audio (e.g., human administrator, or voice recognition system), audio with DTMF response recognition, or graphical user interface (e.g., a browser for interaction with a web site hosted by gateway 1120). Operation of a conference participant station 1124 is generally preceded by a registration process (e.g., one time) and a login process (e.g., for every session).

Conduct arrangement dialog process 1230 presents prompts (e.g., questions, web page buttons, GUI input controls) and recognizes responses (e.g., audio, requested URLs, forms) from a user of a conference participant station 1124. A result of such a dialog generally posts one or more requests in store 1214. Requests may be validated by process 1230 as discussed above with reference to external participant store 1216. Conduct arrangement dialog 1230 may prompt for and receive information for describing the participant and registering the participant. This information may be added to store 1216 by process 1230. Process 1230 may suggest a location for the conference (e.g., nearest conference center 1122) and further may designate a particular conference participation station there.

Conduct availability dialog process 1232 presents prompts (e.g., questions, web page buttons, GUI input controls) and recognizes responses (e.g., audio, requested URLs, forms) from a user of a conference participant station 1124. A result of such a dialog generally posts one or more records to a list of dates and times in store 1216 that the external participant is available for attending a conference. Store 1216 may further include intersection results analogous to those discussed above with reference to intersection results 930.

Monitor external participant availability process 1234, determines whether the conference should be rescheduled due to insufficient response by the external participant including the network and equipment necessary for participation according to conference plans 1220. Process 1234 may require station 1124 to provide a response within a session identified to the conference participant (e.g., suitable identification via log on). The required response may be an email reply to a notice provided by notify process 1226. Process 1234 may require station 1124 to be in session with the conference participant a suitable time prior to the start time for the conference. This requirement may be imposed so that a cancellation or rescheduling due to failure to be in session will meet lead time requirements for notice to others (e.g., so unnecessary transit is avoided). As discussed above, lead time for notification and transit time may be stored in conference plans 1220.

Conduct conference for external participants process 1236 provides screens for conference control and performs audio and video communication during the scheduled conference time. At the end of the period for conferencing defined by conference plans 1220, process 1236 terminates audio and video communication. Another scheduled conference for the same participant may begin without loss of a link and/or without loss of use of equipment. Process 1236 cooperates with notify process 1226 for conference control as discussed herein, for example, to provide a screen sequence of the type discussed above with reference to Table 4.

In system architecture 1200, conference participant station 1124 communicates with processes that do not have write access to conference plans 1220 and has no access to governed participants store 1212. Malicious posting of requests to conference requests store 1214 may result in fines exacted by payment process 1224. Such requests may be denied with suitable validation logic in processes 1218 and 1222. For example, validation may require a minimum period between requested dates and times, a minimum period between posting of requests, no more than a maximum quantity of pending requests, that all requested participants be consistent with rules 1212 and 1216, and no more than a maximum quantity of scheduled conferences.

Architecture 1200 may facilitate relatively short conferences with relatively short advance notice because conference participants may, by using any mix of internal and external conference participant stations, avoid transit delays. Conference plans 1220 may include a log of conferences (e.g., 702), including completed conference status (e.g., successful, preterminated by equipment failure, preterminated by a conferee), names of participants, and duration. The log may further include cumulative quantity of conferences in a suitable interval of time and cumulative total duration of conferences. Schedule conference process 1218 and reschedule process 1222 may refer to such a log to validate a request (e.g., where a rule 1212 prescribes a budget of permitted conference quantity and/or cumulative duration). The conference log may be reported back to proprietary data and processes 1208 to facilitate proprietary functions (e.g., assuring that rules are met, tracking a personal conferencing budget, tracking expenses). Reporting may be immediately upon completion of a conference or periodically (e.g., daily, weekly).

Architecture 1200 supports proactive notification to external participants. For example, when a rule 1212 (perhaps and conference log as discussed above) permits a conference and no conference has been scheduled, notify process 1226 may provide suitable advance notification, for instance, prompting external participants to post a request for a conference.

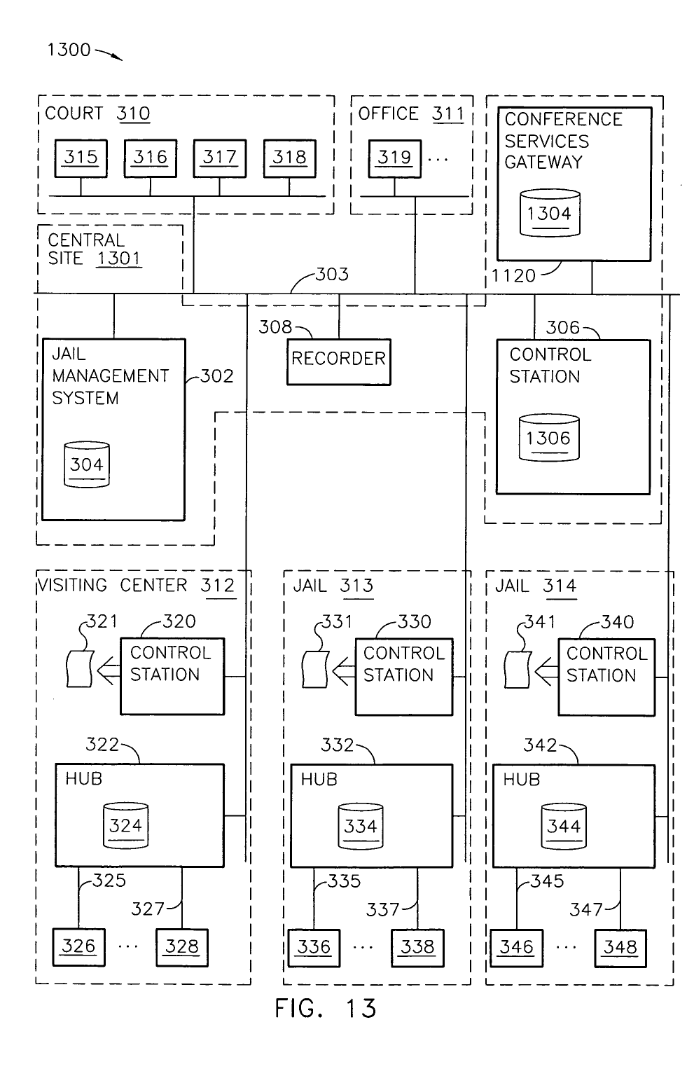

System 1300 of FIGS. 12-13 is an example of a system 1102 suitable for prisoner visitation and used by supervisors, administrators, coordinators, governed participants and external participants as discussed above. System 1300 includes stations at six sites: central site 1301, court 310, office 311, visiting center 312, jail 313, and jail 314. Enterprise network 303 couples all sites for communication. In system 1300, items with reference numbers in the 300's have structures and functions generally as discussed above. Other implementations of system 1300 include any number of sites and any number of stations per site. Sites may be in separate physical locations.

Central site 1301 includes jail management system 302 having store 304, recorder 308, control station 306 having store 1306, and conference services gateway 1120 having store 1304. Store 304 (e.g., including database 206) and processes that are performed by jail management system 302 (e.g., process 202) exemplify proprietary assets of an enterprise that are subject to strict limitations on access. For example, in one implementation of the roles described above in Table 6, only supervisors have access to store 304 and to processes performed by jail management system 302 and control station 306 is used by an administrator to request conferences as directed by governed participants at any site (e.g., primarily sites 310, 311, and 1301).

Processes and stores discussed above with reference to system architecture 1200 may be implemented at sites 1301, 312, 313, and 314 in any manner suitable for reliable operation of system 1300. In one implementation, proprietary data and processes 1203 is implemented in jail management system 302 and control station 306. For instance, only request conference process 1204 is implemented on control station 306. Processes of enterprise conferencing subsystem 201 are implemented per site in control stations 306, 312, 313, and 314. All other processes and stores of system architecture 1200 are implemented in conference services gateway 1120 of central site 1301. Specifically, update process 1210 reads data (1206) from store 304 and stores data (1212) in store 1304.

Architecture 1200 permits conferencing functions to be performed on equipment and software maintained by an organization not part of the enterprise. Maintenance of hardware and software of enterprise proprietary data and processes may be independent of maintenance of hardware and software of conferencing services. For example, jail management system 302 may be physically secured apart from all other equipment of conferencing system 1300.

Conventionally, telephone calls from a prisoner to an external participant require call initiation by the prisoner. In architecture 1200, a conference (e.g., audio only or audio and video) may be initiated by an external participant after registration and log in.

The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

1. A conference services gateway comprising:
a first interface to a public network for communication with a first provided conference participant station;
a second interface to an enterprise network for communication with a second provided conference participant station, the enterprise network coupled to a provided first database describing availability of governed participants; and
a server, coupled to the first and the second interfaces, that repeatedly receives data from the first database for posting to a second database; so that scheduling a conference to include the first and second conference participant stations is accomplished with reference to the second database and without read access to the first database.

2. The gateway of claim 1 wherein the server schedules the conference.

3. The gateway of claim 2 wherein the second database comprises a first conference schedule for the conference so that further conference scheduling is accomplished with further reference to the first conference schedule.

4. The gateway of claim 1 wherein data is repeatedly received without repeated requesting.

5. The gateway of claim 1 wherein receiving data is unsolicited by the conference services gateway.

6. The gateway of claim 1 wherein the server conducts a transaction for payment for the conference.

7. The gateway of claim 1 wherein the server conducts a transaction via the first interface for payment for the conference.

8. The gateway of claim 1 wherein the server reschedules the conference in response to determining that a particular participant of the conference is not available.

9. The gateway of claim 8 wherein the particular participant comprises equipment.

10. The gateway of claim 8 wherein the particular participant comprises the governed participant.

11. The gateway of claim 8 wherein the particular participant comprises an external participant.

12. The gateway of claim 1 wherein the server receives a request for the conference via the first interface so that scheduling the conference is in accordance with the request.

13. The gateway of claim 1 wherein the server receives a request for the conference via the second interface so that scheduling the conference is in accordance with the request.

14. A method for arranging a conference among governed and external participants, the method comprising:
receiving a request for a conference;
receiving unsolicited data describing governed participant availability; and
scheduling the conference with reference to the unsolicited data.

15. The method of claim 14 wherein the request is received via an interface to a public network.

16. The method of claim 14 wherein the request is received via an interface to an enterprise network.

17. The method of claim 14 further comprising:
receiving second data describing availability of at least one external participant; and
scheduling the conference with further reference to the second data.

18. The method of claim 14 further comprising:
monitoring availability of a particular participant of the conference; and
canceling the conference in accordance with determining unavailability of the particular participant.

19. The method of claim 18 wherein the particular participant comprises equipment.

20. The method of claim 14 further comprising:
receiving indicia of payment for the conference from at least one external participant; and
assuring payment for the conference in accordance with the indicia of payment.

21. The method of claim 14 further comprising conducting the conference as scheduled.

22. The method of claim 14 further comprising:
monitoring availability of a particular participant of the conference; and
rescheduling the conference in accordance with determining unavailability of the particular participant.

23. A computer programmed product comprising instructions for performing the method of claim 14.

24. A system comprising:
means for receiving unsolicited data describing governed participants;
means for receiving a request for a conference to include a governed participant and an external participant; and
means for scheduling a conference in accordance with the request.

25. The system of claim 24 wherein the request is received via an interface to a public network.

26. The system of claim 24 wherein the request is received via an interface to an enterprise network.

27. The system of claim 24 further comprising:
means for receiving second data describing availability of at least one external participant; and
means for scheduling the conference with further reference to the second data.

28. The system of claim 24 further comprising:
means for monitoring availability of a particular participant of the conference; and
means for canceling the conference in accordance with determining unavailability of the particular participant.

29. The system of claim 28 wherein the particular participant comprises equipment.

30. The system of claim 24 further comprising:
means for receiving indicia of payment for the conference from at least one external participant; and
means for assuring payment for the conference in accordance with the indicia of payment.

31. The system of claim 24 further comprising conducting the conference as scheduled.

32. The system of claim 24 further comprising:
means for monitoring availability of a particular participant of the conference; and
means for rescheduling the conference in accordance with determining unavailability of the particular participant.
